(19) United States
(12) Patent Application Publication
(10) Pub. No.: US 2008/0059757 A1
(43) Pub. Date: Mar. 6, 2008

(54) Convolver Architecture for Vector Processor

(75) Inventor: Howard G. Sachs, Santa Clara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Telairity Semiconductor, Inc., Santa Clara, CA (US)

(21) Appl. No.: 11/927,352

(22) Filed: Oct. 29, 2007

Related U.S. Application Data
(63) Continuation of application No. 11/656,143, filed on Jan. 19, 2007.
Application No. 11/656,143 is a continuation-in-part of application No. 11/126,522, filed on May 10, 2005.

(51) Int. Cl. G06F 15/76; G06F 9/02

(52) U.S. Cl. 712/4; 712/E09.002

(57) ABSTRACT

A vector processor includes a set of vector registers for storing data to be used in the execution of instructions and a vector functional unit coupled to the vector registers for executing instructions. The functional unit executes instructions using operation codes provided to it which operation codes include a field referencing a special register. The special register contains information about the length and starting point for each vector instruction. A series of new instructions to enable rapid handling of image pixel data are provided.

### CROSS REFERENCE TO RELATED APPLICATION

This application is a continuation of U.S. application Ser. No. 11/656,143, filed Jan. 19, 2007, which was a continuation-in-part of U.S. application Ser. No. 11/126,522, filed May 10, 2005, entitled “Vector Processor with Special Purpose Registers and High Speed Memory Access,” the entire disclosure of which is incorporated herein by reference.

### BACKGROUND OF THE INVENTION

This invention relates to processors for executing stored programs, and in particular to a vector processor employing special purpose registers to reduce instruction width and employing multi-pipe vector block matching.

Vector processors are processors which provide high level operations on vectors, that is, linear arrays of numbers. A typical vector operation might add two 64-entry, floating point vectors to obtain a single 64-entry vector. In effect, one vector instruction is equivalent to a loop with each iteration computing one of the 64 elements of the result, updating all the indices and branching back to the beginning. Vector operations are particularly useful for image processing or scientific and engineering applications where large amounts of data must be processed in generally a repetitive manner. In a vector processor, the computation of each result is independent of the computation of previous results, thereby allowing a deep pipeline without generating data dependencies or conflicts. In essence, the absence of data dependencies is determined by the particular application to which the vector processor is applied, or by the compiler when a particular vector operation is specified.

A typical vector processor includes a pipeline scalar unit together with a vector unit. In vector-register processors, the vector operations, except loads and stores, use the vector registers. Typical prior art vector processors include machines provided by Cray Research and various supercomputers from Japanese manufacturers such as Hitachi, NEC, and Fujitsu. Processors such as provided by these companies, however, are usually physically quite large, requiring cabinets filled with circuit boards. Such machines therefore are expensive, consume large amounts of power, and are generally not suited for applications where cost is a significant factor in the selection of a particular processor.

One technology where reduction in cost of processors greatly expands markets is image processing. There are now many well known image encoding and decoding technologies used to provide full-speed full-motion video with sound in real time over limited bandwidth links. Such applications are particularly suitable for lower cost video processors. Reduction in the cost of such processors, however, requires substantial reductions in their complexity, and implementation of such processors on integrated circuits typically precludes the use of 64-bit instruction words. The reduction in instruction width, however, so diminishes the capability of the processor as to render it less than desirable for such image processing, scientific or engineering applications.

### BRIEF SUMMARY OF THE INVENTION

This invention provides a vector processor with limited instruction width, but which provides features of a processor having a greater instruction width by virtue of a special purpose register, and the referencing of that register by various instructions. This enables a limited width instruction to address the vector memory and provide the functionality of a larger processor, but without requiring the space, multiple integrated circuits, and higher power consumption of a larger processor. In addition, the simplicity of the design enables implementation on a single integrated circuit, thereby shortening signal propagation delays and increasing clock speed. The special purpose registers are set up by a scalar processor, and then their contents are reused without the necessity of reissuing new instructions from the scalar processor on each clock cycle. All vector instructions include a special field which indexes into these special registers to retrieve the attributes needed for executing the vector instructions.

In a preferred embodiment the vector processor includes a set of vector registers for storing data to be used in the execution of instructions and a vector functional unit which is coupled to the vector registers for executing instructions. The functional unit executes the instructions in response to operation codes provided to it, and those operation codes include a field which references a special register. When each instruction is executed reference is made to both the operation code and the special register, and the contents of both the operation code and the special register are used for the execution of the instruction. In one implementation, each vector instruction includes a length and a starting point, and a special register is used to store the information about the length and starting point for each vector instruction.

The invention also provides a memory organization for efficient use of the processor. In particular, a memory architecture is provided in which pipelined accesses are made to groups of banks of SRAM memories. A retry capability is provided to allow multiple accesses to the same bank. Data is moved into and out of the banks of SRAM using a parallel loading technique from a shift register.

Preferably the memory system includes a group of access ports for enabling access to the memory, a set of address lines and a set of data lines coupled to the access ports to receive address information and data from the access ports, and a pipelined series of address decoder stages coupled to the address lines. As addresses arrive, they are transferred from decoder to decoder, and each decoder compares the address on the address lines with a set of addresses assigned to that decoder corresponding to the memory banks associated with it. A first set of memory banks is coupled to the address lines and the data lines between a first address decoder and a second address decoder in the series of address decoders, and a second set of memory banks is coupled to the address lines and the data lines after the second address decoder in the series of address decoders. A shift register connected to each of the sets of memory banks enables bock loads and stores to the memory banks.

An additional aspect of the invention is the provision of instructions for invoking the special register described above. This register stores information about the length and starting point for each vector instruction. In one embodiment a computer implemented method for executing a vector instruction which includes an operation code and references to various registers, includes the steps of decoding the vector instruction to obtain information about the operation code defining the particular mathematical, logical, or other type operation to be performed on a vector. At the same time the vector instruction is decoded to obtain an address of a first vector register where the at least one vector upon which the operation to be performed is stored, the address of a second vector register where the result of the operation is to be stored, and the address of a third register which stores the starting element and the vector length. The vector instruction is then executed using information from the first and third registers.

### BRIEF DESCRIPTION OF THE DRAWINGS

FIG. 1 is a block diagram illustrating the overall processor architecture of a preferred embodiment;

FIG. 2 is a block diagram illustrating internal components of the vector processor;

FIG. 3 is a diagram illustrating further details about the vector processor;

FIG. 4 is a diagram illustrating the data paths for the vector processor;

FIG. 5 is a block diagram illustrating the special purpose registers within a single vector pipe in the vector processor;

FIG. 5b is a diagram illustrating the G register of FIG. 5;

FIG. 6 is a block diagram illustrating how the vector registers communicate with memory;

FIG. 7 illustrates the format for a typical vector instruction for a single vector pipe;

FIG. 8 illustrates a typical vector instruction for multiple vector pipes; and

FIG. 9 illustrates a skip and repeat operation.

FIG. 10 illustrates the Move One Scalar to G Register (m1sg) instruction;

FIG. 11 illustrates the Move Two Immediates to G Register (m2ig) instruction;

FIG. 12 illustrates the Move Two Scalars to G Register (m2sg) instruction;

FIG. 13 illustrates the Move Three Scalars to G Register (m3sg) instruction;

FIG. 14 illustrates the Move Higher G Register to Scalar (mhgs) instruction;

FIG. 15 illustrates the Move Immediate to G Register (mi(vlg,seg,rg,skg,sg)) instruction;

FIG. 16 illustrates the Multi-Pipe Move Immediate to G Register (mmi(vlg,seg,rg,skg,sg)) instruction;

FIG. 17 illustrates the Multi-Pipe Move Scalar Register to G Register (mms(vlg,seg,rg,skg,sg)) instruction;

FIG. 18 illustrates the Multi-Pipe Move Scalar to Higher G Register (mmshg) instruction;

FIG. 19 illustrates the Multi-Pipe Move Scalar to Lower G Register (mmslg) instruction;

FIG. 20 illustrates the Move Scalar Register to G Register (ms(vlg,seg,rg,skg,sg)) instruction;

FIG. 21 illustrates the Move Scalar to Higher G Register (mshg) instruction;

FIG. 22 illustrates the Move Scalar to Lower G Register (mslg) instruction;

FIG. 23 illustrates the Vector Load Byte Indexed (vlbi) instruction;

FIG. 24 illustrates the Vector Load Byte Offset (vlbo) instruction;

FIG. 25 illustrates the Vector Load Doublet Indexed (vldi) instruction;

FIG. 26 illustrates the Vector Load Doublet Offset (vldo) instruction;

FIG. 27 illustrates the Vector Store Byte Indexed (vstbi) instruction;

FIG. 28 illustrates the Vector Store Byte Masked Indexed (vstbmi) instruction;

FIG. 29 illustrates the Vector Store Byte Masked Offset (vstbmo) instruction;

FIG. 30 illustrates the Vector Store Byte Offset (vstbo) instruction;

FIG. 31 illustrates the Vector Store Doublet Indexed (vstdi) instruction;

FIG. 32 illustrates the Vector Store Doublet Masked Index (vstdmi) instruction;

FIG. 33 illustrates the Vector Store Doublet Masked Offset (vstdmo) instruction;

FIG. 34 illustrates the Vector Store Doublet Offset (vstdo) instruction;

FIG. 35 is a block diagram of a vector memory system;

FIG. 36 is a more detailed illustration of the vector memory system;

FIG. 37 is a block diagram illustrating in more detail one memory bank;

FIG. 38 illustrates the store control pipeline;

FIG. 39 illustrates the load control pipeline;

FIG. 40 is a block diagram illustrating in more detail the load data path;

FIG. 41 is a block diagram illustrating how the groups of banks interface with the DMA shift register;

FIG. 42 is a diagram illustrating the input signals provided to one memory bank;

FIG. 43 is a more detailed diagram of the bank priority encoder;

FIG. 44 is a block diagram illustrating details of the bank index multiplexer; and

FIG. 45 illustrates the 5:1 multiplexer for selecting the write data for a particular bank and the input and output signals for the memory bank.

### DETAILED DESCRIPTION OF THE INVENTION

This invention provides a vector processor which may be implemented on a single integrated circuit. In a preferred embodiment, five vector processors together with the data input/output unit and a DRAM controller are implemented on a single integrated circuit chip. This chip provides a video encoder which is capable of generating bit streams which are compliant with MPEG-2, Windows Media 9, and H.264 standards.

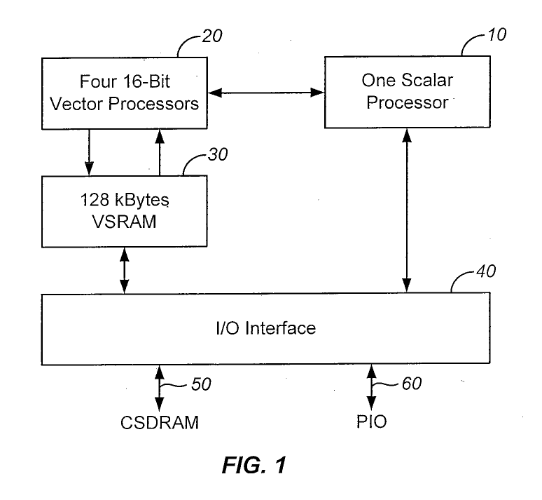

FIG. 1 is a block diagram illustrating the basic structure of a microcontroller. The microcontroller includes a scalar processor 10, four independent 16-bit vector processors 20, high speed static random access memory 30, and an input/output (I/O) interface 40. Interfaces to the microcontroller include two 64-bit wide unidirectional buses 50 (one input and one output) for communication with synchronous DRAM, and two 32-bit wide unidirectional buses 60 (one input and one output) used for programmed I/O. The vector register memory 30 is implemented in SRAM and consists of four banks of 16-vector registers. Each register has 32 elements, thereby providing a total of 2,048 vector registers. The use of a large VSRAM to provide memory 30 enables maintaining an entire data set for an algorithm in a memory that has very fast access time compared to the relatively slower DRAM memory.

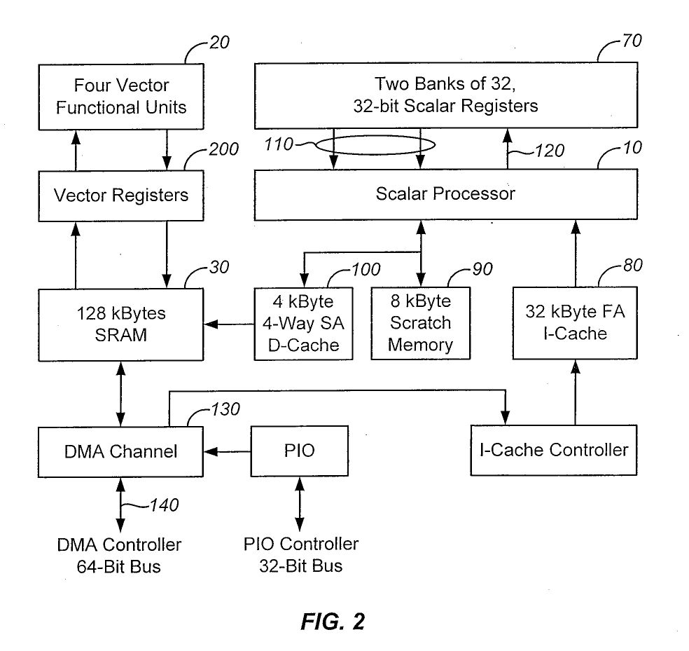

FIG. 2 is a more detailed block diagram of the microcontroller shown more simply in FIG. 1. In FIG. 2, the scalar processor includes an instruction unit, and integer execution unit and two register file banks. The integer execution unit typically includes a shifter, an adder, a multiplier, and logical functions. The two register file banks 70 are shown coupled to the scalar processor 10. In addition, the scalar processor is coupled to a 32-k Byte instruction cache 80, an 8-k Byte memory scratch memory 90, and a 4-k Byte set associated data cache 100. As shown in FIG. 2, the data cache is coupled to the SRAM 30.

The scalar processor will typically be a single issue design with hardware interlocks. Instructions issue in order and complete in order with instruction decode requiring one clock. All operations performed by the scalar processor are 32 bits, but support 32, 16, and 8-bit data values. All execution units complete in one clock except the multiplier which requires four clocks, data cache loads which require three clocks, and the 32-bit shift which requires two clocks.

The two banks of 32 entry scalar register files 70 provide one file for the supervisor, and another file for applications. As shown in FIG. 2, each element in the register file is 32 bits, and the scratch memory 90 provides storage for any spilling of the registers. Scalar processor 10 accesses the register files using read ports 110 and write port 120. Simple instructions are executed in the scalar processor in a nine clock pipeline of icache fetch, icache hit and way select, instruction decode, operand fetch, execute 0, execute 1, execute 2, execute 3, writeback.

The scalar processor 10 has four condition code registers (c0, c1, c2, c3), each with a single flag bit. These 1-bit flags reflect the overflow (O) and carry (C) conditions. The meaning of the condition code flag depends on the type of instruction that set the flag:
signed arithmetic instruction when overflow,(MSB xor MSB+1)−>flag; (1)
unsigned arithmetic instruction when a carry=(MSB+1)−>flag; (2)
saturated arithmetic instruction, signed or unsigned, when overflow−>flag; and (3)
compare instruction(EQ, LE, . . . )−>flag. (4)

Instructions that set a condition code must specify which one of the four registers is to be used. Some instructions do not affect the condition codes. If the programmer needs a “sticky flag” (for example, to see if any result in a loop overflowed), an add with carry instruction can be used with an immediate value of 1 as an input.
ADDC R1,(R1),C1;

So if R1 is cleared before the loop and contains a 0 at the end of the loop, the conditional flag was never set and overflow never occurred in the loop.

An instruction that specifies a condition code register to be set as a result of the operation performed also modifies the CC flag. For example, an instruction that compares two registers for equality and chooses c2 as the condition code register destination will set the flag. In contrast, a logical instruction such as the logical-and instruction cannot specify a condition code register and so leaves all condition code flags unmodified.

A branch on condition instruction will not modify the cC flag. In some instructions a cC register is used as a carry in and if there is an overflow from the operation, then the same cC register is modified.

An overflow is generated when the result of an arithmetic operation falls outside the range of representable numbers, thus producing an incorrect result. In 2s complement arithmetic, overflow is detected when the MSB and MSB+1 have different signs. Both operands must be sign-extended to MSB+1. A Carry is generated when a “1” is generated in the MSB+1 position.

The Vector Mask registers (mM) 110 are used to store condition codes for the vector functional units. Each vector pipe has eight M registers that store a single bit for each element in the vector register. If the vector length is set to 32, then the M register is 32 bits. The meaning of the condition code flag depends on the type of instruction that set the flag:
Signed arithmetic instruction when overflow, (MSB xor MSB+1)−>flag
Unsigned arithmetic instruction when a carry=(MSB+1)−>flag
Saturated arithmetic instruction, signed or unsigned, when overflow−>flag
Compare instruction(EQ, LE, . . . )−>flag

At the end of a vector instruction, the M register can be moved to a scalar register and a bit reduction operation performed to check if any flags were set during the vector operation. The Mask registers can also be used to hold carry values for instructions that have a carry in. For example, if double precision (32-bit) arithmetic requires:
vaddu nVD,nVA,nVB,mM add low bits unsigned, carry to mM
vaddc nVD,nVA,nVB,mM add high bits with carry from mM

Vector Mask registers can also be used with shift instructions on the vector side. For example, if a shift instruction shifts out any value of 1, the vector mask is set. This can be used to find the largest number in a vector and then scale the vector accordingly. The M register is used in the vector merge instruction. In this case, the mask bit selects whether the element from source one or the element from source two is written to the destination register.

FIG. 2 also shows more detail for the block diagram of the vector processor. The architecture has four vector processors 20, each with four 16-bit wide functional units (for a total of 16). The vector unit receives its data from the 128 banks of the on chip SRAM 30. Data is transferred under program control of the scalar processor 10 using a DMA controller and channel 130.

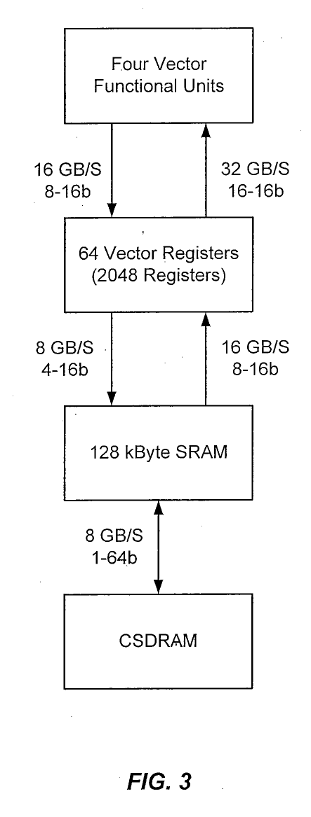

The data is transferred from the DRAM backing store through the high-speed system bus 140 to the SRAM. Data from the SRAM is transferred by the memory controller to the register files by the scalar processor 10, and is interlocked with the appropriate instructions in the hardware. The memory interface has a capacity of twelve 16-bit simultaneous transfers per clock. FIG. 3 illustrates typical bandwidths of the vector processor in a preferred implementation.

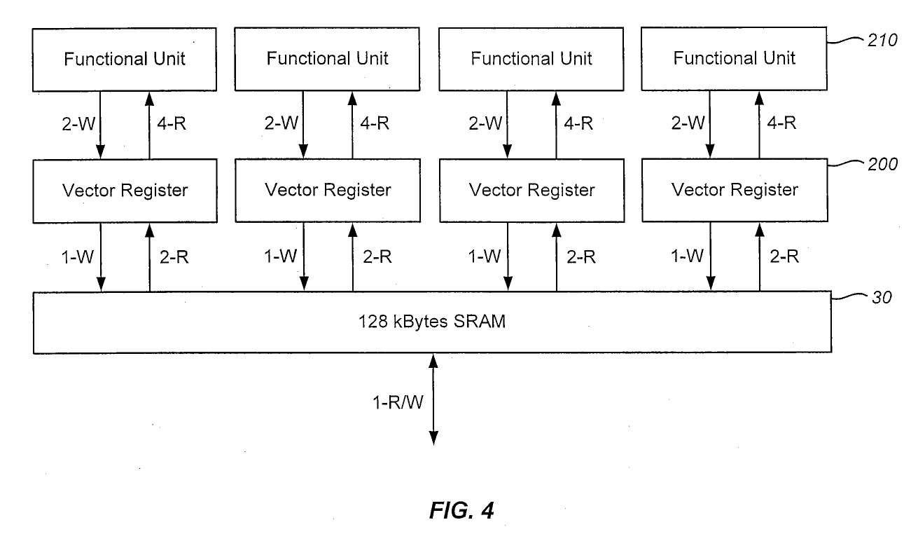

FIG. 4 shows the vector unit register organization. There are four vector register banks 200, each with 16 vector registers. Each vector register has 32 register elements that are 16-bits wide. Each of the four banks is identical with five read ports and four write ports. Each 32-entry vector register has two read ports and one write port.

The vector function units 210 are capable of running two operations at the same time in each vector unit. Four vector functional units can have eight operations occurring simultaneously. Each vector function unit is capable of four reads and two writes simultaneously. To keep the functional units busy, the SRAM 30 buffers feed the vector registers 200 using memory controllers. These memory controllers are programmed by the scalar processor 10, but are located in each of the functional units 210. There are three memory controllers in each functional unit, two loads and one store.

The vector processor 210 supports chaining. For example, if the first instruction issued is a multiply that stores the result in a vector register, a second instruction can issue on the next clock that reads the result in the register file from the first operation, and performs a different operation on the result of the first multiply. The hardware automatically schedules the second instruction when the result of the first operation is complete by register scoreboarding of the vector register elements.

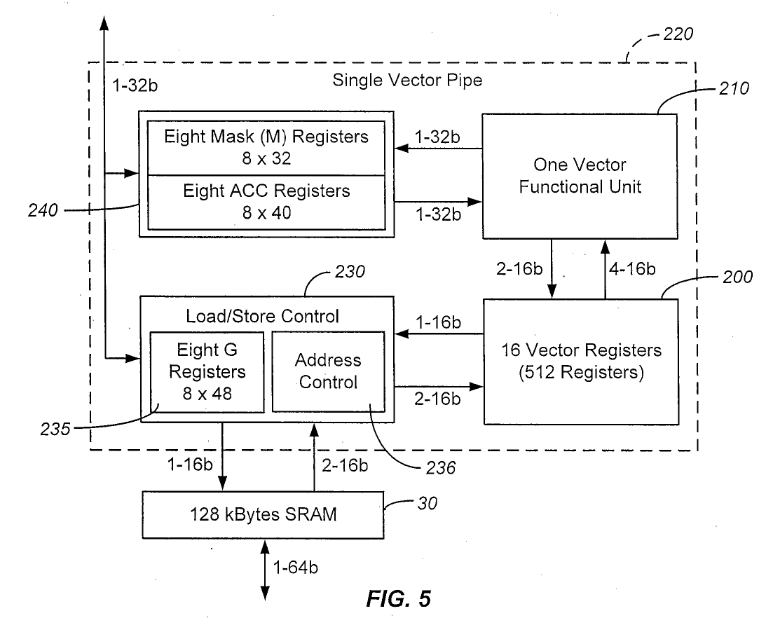

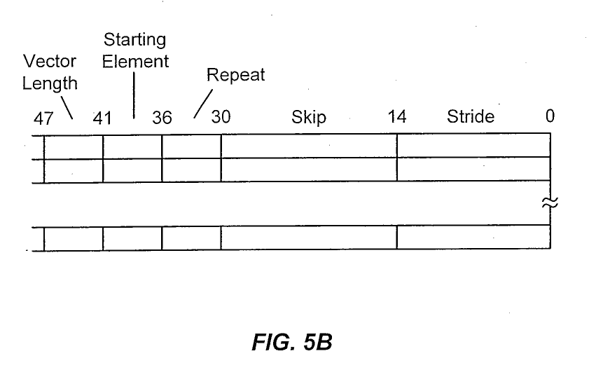

FIG. 5 is a block diagram of a single vector pipe 220. The single vector pipe includes a vector functional unit 210 and 16 vector registers 200. These units are coupled to a load/store control 230 and another set of registers 240. The vector pipe is coupled to the SRAM 30 as also shown. The vector pipe includes within load/store control 8 G registers 235 and an address control block 236.

The special “G” register file 235 is organized as eight 48-bit registers. This register file is capable one read and one write, and can be read and written by various instructions, as well as read by the SRAM load store controller 236. As will be described below in more detail, vector load and store operations use the “G” register file to obtain the desired values for a series of parameters. In the preferred embodiment these parameters include (1) vector length, (2) starting element, (3) repeat, (4) skip, and (5) stride. The bit positions where these values are stored are:
gG[47:42]<−(6-b Vector Length)
gG[41:37]<−(5-b Starting Element)
gG[36:31]<−(6-b Repeat)
gG[30:15]<−(16-b Skip)
gG[14:0]<−(15-b Stride)
The G register is illustrated in more detail in FIG. 5b.

Whenever an operation is carried out using a vector opcode, that instruction includes an index into the G register to specify the desired parameters for that operation. In the preferred embodiment, to select one of the eight 48-bit registers, the G field in the vector instruction will be three bits in length.

The vector pipe shown in FIG. 5 also includes a special purpose dual ported register file referred to as the “M” register. This register holds vector mask data. It is organized as eight 32-bit registers, and can be read or written by various instructions. The operation of these mask registers was described above.

Each vector pipe also has a special purpose 40-bit register file called aACC. This register file holds the 40-bit result of each MAC instruction, and each of the two add/sub reduction 24-bit Accumulators. The Accumulator is loaded from the ACC register file at the beginning of each MAC or reduction operation. At the end of the operation the final result in the Accumulator is stored in the ACC register. This register file is dual-ported to allow two operations to occur at the same time.

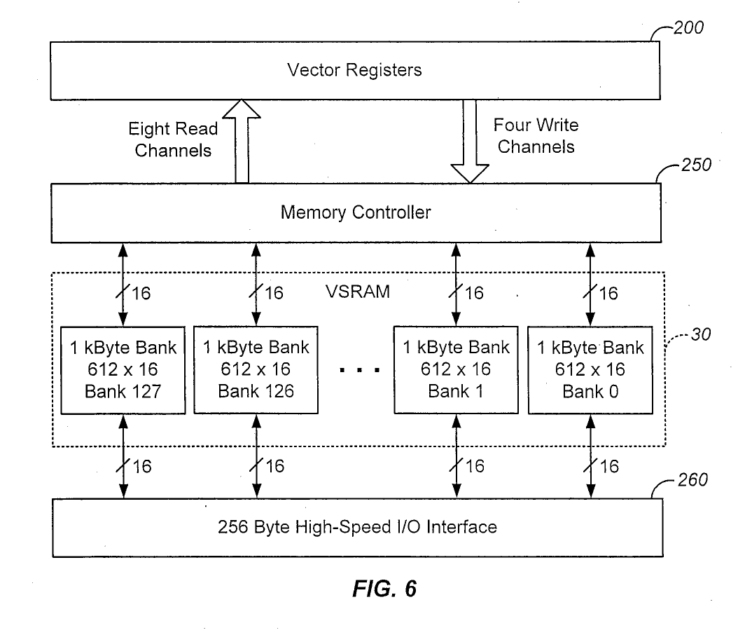

FIG. 6 is a block diagram of the high-speed SRAM and memory controller. The vector registers are capable of 32 reads and 16 writes per pipe, however only five reads and four writes can occur at the same time. Since only one load or store instruction can be issued at a time, obtaining twelve operations takes either twelve vector instructions, or a multi-pipe load or store operation where the attributes for each operation are located in the local G register. For each vector register file, there are five read ports—two ports for the function unit on pipe 0, two ports for the function unit on pipe 1 and one port for store data. Each vector pipe has four write ports—one port for the function unit on pipe 0, one port for the function unit on pipe 1, one port for loads on pipe 0 and one port for loads on pipe 1.

As shown in FIG. 6, the SRAM is composed of 128 memory banks. Each memory bank is organized as 512×16 bits, and is capable of one read or one write per clock. Each bank has twelve address ports, eight read ports, and four write ports. Only one address port and one read or write port is selected for action in one clock. Addressing for the banks uses bits 1 through 7 to determine the bank address, therefore, a sequential block of 256 bytes will address all of the banks.

A high speed interface is provided to all banks of the SRAM. The interface accumulates 256 bytes in a buffer, and then transfers all 256 bytes in four clocks to all of the banks. This 256-byte buffer is read or written from the SRAM on 256-byte boundaries. If any vectors are in flight, they are held for one clock while the read or write occurs. The Memory Controller routes each of the potential twelve read or writes from the vector register to the proper banks. Since each vector register may have up to 32 elements, a stride of one assures 32 consecutive banks will be addressed. Since the bank can read or write on every clock there is not a bank conflict between addresses in the same vector, however, there may be bank conflicts due to address conflicts from other vectors that are executing. A single conflict will cause one of the addresses to be delayed by four clocks. The priority is hardwired by vector unit, with vector unit 0 having the highest priority and vector unit 3 the lowest priority. Within each vector unit, load 0 has higher priority over load 1, and the lowest priority is the store operation.

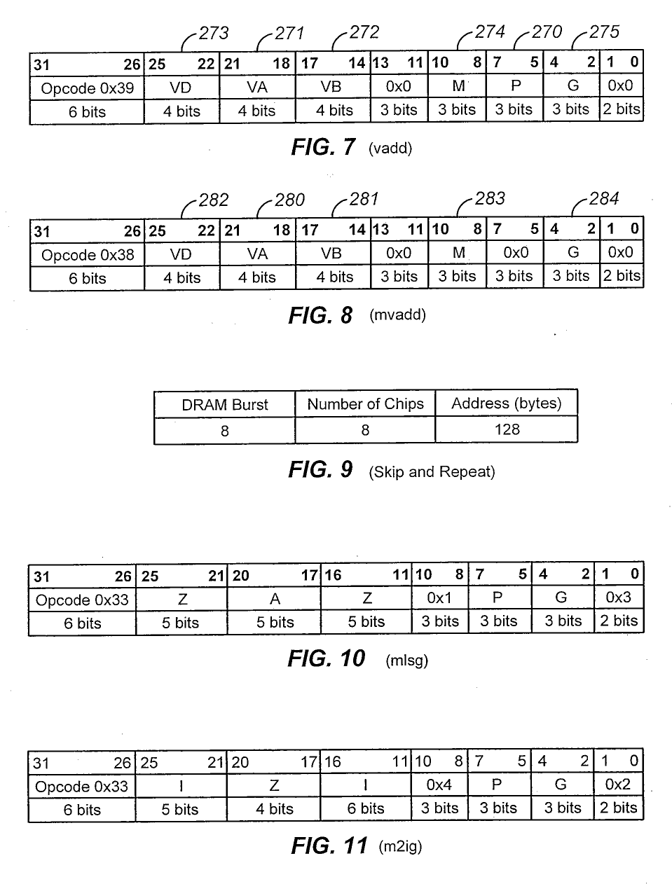

FIG. 7 is a diagram of a typical vector instruction “Vector Add (vadd)” such as employs the G register. The vadd instruction provides an addition function. The vector pipe is selected by the 3-bit P field 270. The arithmetic functional unit is selected by the hardware. The vector register as specified by the VA field 271 has each element added to the vector element of the vector register vVB 272, with each result element placed into the vVD vector register 273. The 3-bit M field 274 selects the vector pipe M register that contains the vector mask registers. If the sum has overflowed, a one is placed in the M register. The G field 275 selects the appropriate G register containing the starting element and vector length.

The format of the vadd instruction is:
vadd vVD,vVA,vVB,mM,P,gG

A typical implementation is:

```
i = 1, j = starting element
while (i <= vector length)
  vVD(j)[15:0] <- vVA(j)[15:0] + vVB(j)[15:0]
  mM[j] <- 1 if result overflows else 0
i++, j = (j+1) mod 32;
endwhile
```

The fields in FIG. 7, and in many of the subsequent instructions below, can be understood by reference to the chart below. The chart shows several types of registers to which instructions may refer, a designation for the register, a list of that type register, and an example of how the register is referenced.

| Register | Designation | Register List | Example |
|---|---|---|---|
| Scalar General register | r | rA, rB, rD, rS | r15 |
| Condition Code register | c | cC | c2 |
| Vector General register | g | gG | g6 |
| Vector register | v | vVA, vVB, vVD | v12 |
| Accumulator register | a | aACC | a5 |
| Mask register | m | mM | m5 |

Furthermore, in the figures associated with many of the following instructions, reference is made to fields 0x0, 0x1 etc. This nomenclature is intended to indicate that the bits so marked designate hexadecimal 0, hexadecimal 1, etc. In addition, “P” refers to the vector processor pipe number and “G” to the G register.

FIG. 8 is a diagram of a typical multi-pipe vector operation, in this case “Multi-Pipe Vector Add (mvadd),” such as also employs the G register. The format of the mvadd instruction is:
mvadd vVD,vVA,vVB,mM,gG

This instruction is used on all four pipes at the same time. The arithmetic functional unit is selected by the hardware. Each element of the vector register specified by the VA field 280 is added to the vector element of vector register vVB 281. The result element is placed into the vVD vector register 282. The 3-bit M field 283 selects the vector pipe M register that contains the vector mask registers. If the sum has an overflow, a 1 is placed in the M register. The G field 284 selects the appropriate G register containing the starting element and vector length.

A typical implementation is:

```
i = 1, j = Starting Element
while (i <= Vector Length)
  vVD(j)[15:0] <- vVA(j)[15:0] + vVB(j)[15:0]
  mM[j] <- 1 if result overflows else 0
  i++, j = (j+1) mod 32;
endwhile
```

As shown above, the G register is set up by the scalar processor and then used over and over without the necessity of issuing new vector instructions. The G register provides the special attributes needed for execution of the instructions, such as vadd and mvadd. In the case of these instructions the G register provides the vector length and the starting field, thereby providing an indication of how many computations are required and where the addressing starts.

The repeat, skip and stride relate to how an address sequence is generated for vector load and store instructions. The starting address of the first element is computed in the scalar pipe. A stride value is then added to this address and accumulated on every subsequent clock. In addition a skip value is also added to this address stream every nth cycle defined by the repeat field.

The overall impact of the G register is the enablement of a richer opcode set, but without need for long instruction words.

The scalar processor reloads the G register when vector operations occur. The vector operations typically report 32 clocks, thereby providing the scalar processor the opportunity to reload the G register. This capability is enhanced by the vector operation renumbering the contents of the G register when the vector operation begins execution. This enables the G register to be reloaded immediately. The stride feature of the G register is particularly beneficial for video applications in which blocks of pixels from a serial data stream are addressed and processed. The stride allows addressing of the SRAM to step from one location to another where those locations are not contiguous, but are evenly spaced.

The vector processor described above includes many instructions facilitating operations with the G register. These instructions are discussed next.

The “Move One Scalar to G Register (m1sg)” instruction is shown in FIG. 10. The format of the instruction is:
m1sg rA,P,gG
For this instruction the vector pipe is selected by the 3-bit P field. Portions of the contents of general register rA are sent to the selected vector pipe and stored in the addressed gG register. General-purpose register A contains the 6-bit repeat and the 16-bit skip. A typical Implementation is:
gG[47:42]<−gG[47:42] (vector length)
gG[41:37]<−gG[41:37] (starting element)
gG[36:31]<−rA[21:16] (repeat)
gG[30:15]<−rA[15:0] (skip)
gG[14:0]<−gG[14:0] (stride)

The “Move Two Immediates to G Register (m2ig)” instruction is shown in FIG. 11. The format of the instruction is:
m2ig I,P,gG
For this instruction the vector pipe is selected by the 3-bit P field. The immediate value for the vector length is in bits [16:11] (0x20). The starting element is in bits [25:21] (0x00) of the instruction, and is sent to the vector pipe and stored in the addressed gG register. A typical implementation is:
gG[47:42]<−I[16:11] (vector length)
gG[41:37]<−I[25:21] (starting element)
gG[36:31]<−gG[36:31]
gG[30:15]<−gG[30:15]
gG[14:0]<−gG[14:0]

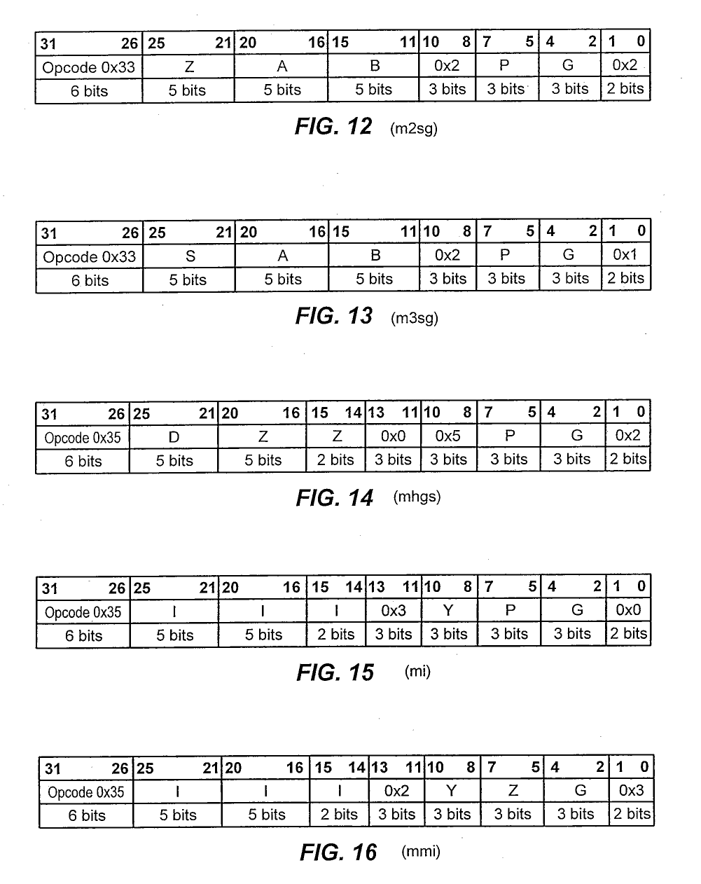

The “Move Two Scalars to G Register (m2sg)” instruction is shown in FIG. 12. The format of the instruction is:
m2sg rA,rB,P,gG
For this instruction the vector pipe is selected by the 3-bit P field. Portions of the contents of the two general registers rA and rB are sent to the selected vector pipe, and stored in the addressed gG register. General-purpose register A contains the 5-bit starting element, and general-purpose register B contains the 6-bit vector length. A typical implementation is:
gG[47:42]<−rB[5:0] (vector length)
gG[41:37]<−rA[4:0] (starting element)
gG[36:31]<−gG[36:31] (repeat)
gG[30:15]<−gG[30:15] (skip)
gG[14:0]<−gG[14:0] (stride)

The “Move Three Scalars to G Register (m3sg)” instruction is shown in FIG. 13. The format of the instruction is:
m3sg rS,rA,rB,P,gG
For this instruction the vector pipe is selected by the 3-bit P field. Portions of the contents of the three general registers rA, rB, and rS are sent to the selected vector pipe and stored in the addressed gG register. General-purpose register S contains the 6-bit repeat, and general-purpose register A contains the 16-bit skip. General-purpose register B contains the 15-bit stride. A typical Implementation is:
gG[47:42]<−gG[47:42] (vector length)
gG[41:37]<−gG[41:37] (starting element)
gG[36:31]<−rS[5:0] (repeat)
gG[30:15]<−rA[15:0] (skip)
gG[14:0]<−rB[14:0] (stride)

The “Move Higher G Register to Scalar (mhgs)” instruction is shown in FIG. 14. The format of the instruction is:
mhgs rD,P,gG
For this instruction the vector pipe is selected by the 3-bit P field. The high-order 17 bits of the gG register are sent to the scalar general-purpose D register. A typical implementation is:
rD[16:0]<−gG[47:31]
rD[31:17]<−0

The “Move Immediate to G Register (mi(vlg,seg,rg,skg,sg))” instruction is shown in FIG. 15. The format of that instruction is:
mi(vlg,seg,rg,skg,sg)I,P,gG

For this instruction the vector pipe is selected by the 3-bit P field. The Stride and Skip Immediate is a 12-bit signed value. (An assembly error will occur if more than twelve bits are specified.) The immediate values as shown in Table 1 are sent to the selected gG register. The MSB of Stride has the sign extended to form a 15-bit value. The MSB of Skip has the sign extended to form a 16-bit value.

TABLE 1
Move Immediate Instruction Immediate Values

| Y | Name | GG | Immediate | Mnemonics | Description | Action |
|---|---|---|---|---|---|---|
| 0 | N/A | | | | | |
| 1 | Vector | 7:42 | [19:14] | ivlg | Move immediate vector | gG<-1 |
| | length | | | | length to the G register | |
| 2 | Start | 1:37 | [18:14] | seg | Move immediate starting | gG<-1 |
| | element | | | | element to the G register | |
| 3 | N/A | | | | | |
| 4 | Repeat | 6:31 | [19:14] | mirg | Move immediate repeat to | gG<-1 |
| | | | | | the G register | |
| 5 | Skip | 0:15 | [25:14] | miskg | Move immediate skip to | gG<-1 |
| | | | | | the G register | |
| 6 | Stride | 4:0 | [25:14] | misg | Move immediate stride to the | gG<-1 |
| | | | | | G register | |
| 7 | N/A | | | | | |

A typical implementation is:
Mivl gG[47:42]<−I[19:14]
mise gG[47:37]<−I[18:14]
mir gG[36:31]<−I[19:14]
misk gG[26:15]<−I[25:14]
gG[30:27]<−I[25]
mis gG[11:0]<−I[25:14]
gG[14:12]<−I[25]

The “Multi-Pipe Move Immediate to G Register (mmi(vlg,seg,rg,skg,sg))” instruction is shown in FIG. 16. The format of that instruction is:
mmi(vlg,seg,rg,skg,sg)I,gG

For this instruction all vector pipes are selected. The immediate values shown in Table 2 are sent to all vector pipes and the selected gG register. The MSB of Stride has the sign extended to form a 5-bit value. The MSB of Skip has the sign extended to form a 16-bit value.

TABLE 2
Multi-Pipe Move Immediate Values

| Y | Name | gG | Immediate | Opcode | Mnemonics | Description | Action |
|---|---|---|---|---|---|---|---|
| 0 | A | | | | | | |
| 1 | Vector | 47:42 | [19:14] | 213 | mmivlg | Multi-pipe move | gG<-1 |
| | length | | | | | immediate vector length | |
| | | | | | | to the G register | |
| 2 | Start | 41:37 | [18:14] | 223 | mmiseg | Multi-pipe move | gG<-1 |
| | element | | | | | immediate starting | |
| | | | | | | element to the G register | |
| 3 | N/A | | | | | | |
| 4 | Repeat | 36:31 | [19:14] | 233 | mmirg | Multi-pipe move | gG<-1 |
| | | | | | | immediate repeat to the | |
| | | | | | | G register | |
| 5 | Skip | 30:15 | [25:14] | 243 | mmiskg | Multi-pipe move | gG<-1 |
| | | | | | | immediate skip to the G | |
| | | | | | | register | |
| 6 | Stride | 14:0 | [25:14] | | mmisg | Multi-pipe move | gG<-1 |
| | | | | | | immediate stride to the | |
| | | | | | | G register | |
| 7 | N/A | | | | | | |

A typical implementation is:
Multi-Pipes gG<−table Immediate

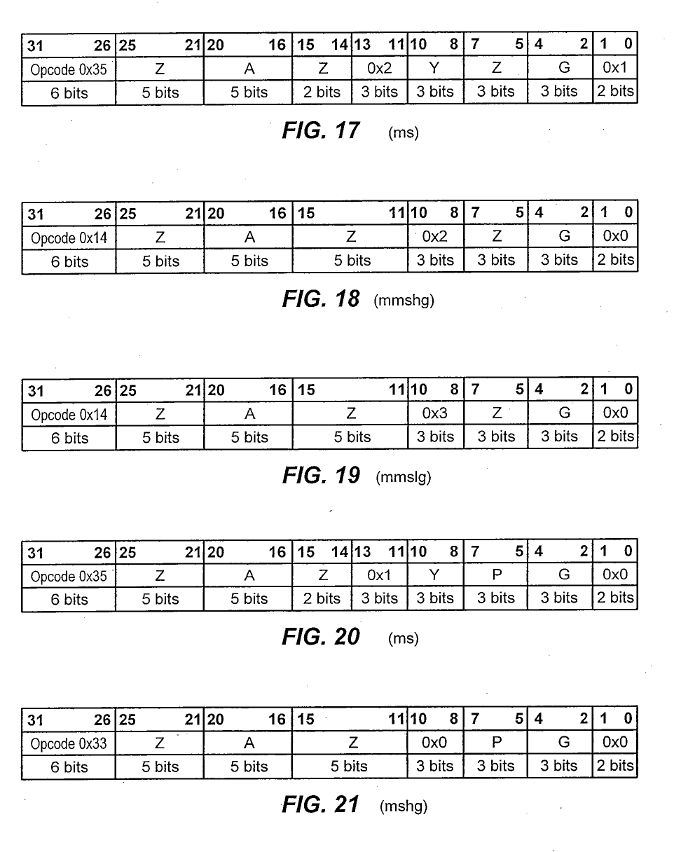

The “Multi-Pipe Move Scalar Register to G Register (mms(vlg,seg,rg,skg,sg))” instruction is shown in FIG. 17. The format of that instruction is:
mms(vlg,seg,rg,skg,sg)rA,gG

For this instruction all vector pipes are selected. The contents of the general-purpose scalar register rA are sent to all vector pipes and the selected gG register. Table 3 describes which bits from general-purpose register rA go to the fields of register gG.

TABLE 3
Multi-Pipe Move Instructions

| Y | Name | gG | RA | Mnemonics | Description | Action |
|---|---|---|---|---|---|---|
| 0 | | | | | | |
| 1 | Vector | 47:42 | 5:0 | mmsvig | Multi-pipe move scalar | gG<-(rA) |
| | length | | | | register to the G registerr | |
| 2 | Start | 41:37 | 4:0 | mmsseg | Multi-pipe move scalar | gG<-(rA) |
| | element | | | | register starting element to the | |
| | | | | | G register | |
| 3 | | | | | | |
| 4 | Repeat | 36:31 | 5:0 | mmsrg | Multi-pipe move scalar | gG<-(rA) |
| | | | | | register repeat to the G register | |
| 5 | Skip | 30:15 | 15:0 | mmsskg | Multi-pipe move scalar | gG<-(rA) |
| | | | | | register skip to the G register | |
| 6 | Stride | 14:0 | 14:0 | mmssg | Multi-pipe move scalar | gG<-(rA) |
| | | | | | register stride to the G register | |
| 7 | N/A | | | | | |

A typical implementation is:
Multi-Pipes gG<−table(rA)

The “Multi-Pipe Move Scalar to Higher G Register (mmshg)” instruction is shown in FIG. 18. The format of that instruction is:
mmshg rA,gG
For this instruction all vector pipes are selected. The contents of general register rA are sent to all of the vector pipes and stored in the addressed gG registers. The contents of general-purpose register rA are sent to the selected vector pipe and stored in the upper seventeen bits [47:31] of the addressed gG register. A typical A typical implementation of the instruction is:
gG[47:31]<−rA[16:0]

The “Multi-Pipe Move Scalar to Lower G Register (mmslg)” instruction is shown in FIG. 19. The format of the instruction is:
mmslg rA,gG
For this instruction all vector pipes are selected. The contents of general register rA are sent to all of the vector pipes and stored in the addressed G registers. The contents of general-purpose register rA are sent to the selected vector pipe and stored in the lower 31 bits [30:0] of the addressed gG register. A typical implementation of the instruction is:
gG[30:0]<−rA[30:0]

The “Move Scalar Register to G Register (ms(vlg,seg,rg,skg,sg))” instruction is own in FIG. 20. The format of the instruction is:
ms(vlg,seg,rg,skg,sg)rA,P,gG

For this instruction the vector pipe is selected by the 3-bity P field. The contents of the general-purpose scalar register rA sent to the selected vector pipe are then sent to the selected gG register. Table 4 shows which bits from the general-purpose register rA go to the fields of register gG.

TABLE 4
Move Scalar Register Instructions

| Y | Name | gG | RA | Mnemonic | Description | Action |
|---|---|---|---|---|---|---|
| 0 | | | | | | |
| 1 | Vector | 47:42 | 5:0 | msvlg | Move scalar register vector length to the | gG<-1 |
| | length | | | | G register | |
| 2 | Start | 41:37 | 4.0 | msseg | Move scalar register starting element to | gG<-1 |
| | element | | | | the G register | |
| 3 | N/A | | | | | |
| 4 | Repeat | 36:31 | 5:0 | msrg | Move scalar register repeat to the G | gG<-1 |
| | | | | | register | |
| 5 | Skip | 30:15 | 15:0 | msskg | Move scalar register skip to the G | gG<-1 |
| | | | | | register | |
| 6 | Stride | 14:0 | 14:0 | mssg | Move scalar register stride to the G | gG<-1 |
| | | | | | register | |
| 7 | N/A | | | | | |

The “Move Scalar to Higher G Register (mshg)” instruction is shown in FIG. 21. The format of the instruction is:
mshg rA,P,gG
For this instruction the vector pipe is selected by the 3-bit P field. The contents of general-purpose register rA are sent to the selected vector pipe and stored in the upper seventeen bits [47:31] of the addressed gG register. A typical implementation of the instruction is:
gG[47:31]<−gG(rA[16:0]

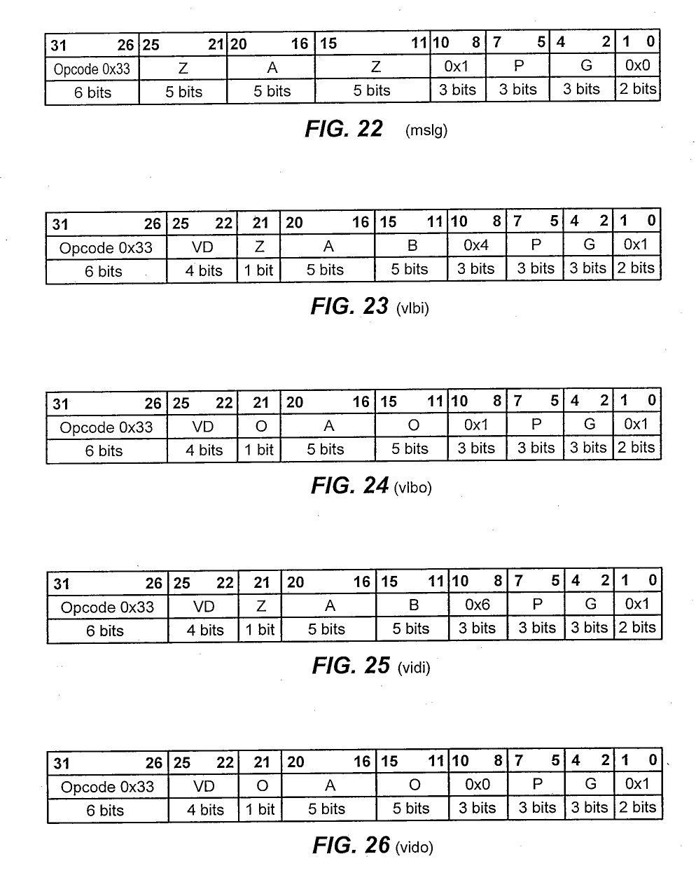

The “Move Scalar to Lower G Register (mslg)” instruction is shown in FIG. 22. The format of the instruction is:
mslg rA,P,gG
For this instruction the vector pipe is selected by the 3-bit P field. The contents of general register rA are sent to the selected vector pipe and stored in the lower 31 bits [30:0] of the addressed gG register. A typical implementation of the instruction is:
gG[30:0]<−rA[30:0]

The “Vector Load Byte Indexed (vlbi)” instruction is shown in FIG. 23. The format of the instruction is:
vlbi vVD,rA,rB,P,gG

For this instruction the vector data is loaded from the Effective Address (EA) in the SRAM to the specified destination vector register vVD. The index from the contents of general-purpose register rB is added to the contents of general-purpose register rA to form the effective SRAM address. The index (rB) is a signed value, and the base (rA) register is an unsigned value. The byte in memory addressed by the EA is loaded into the low-order eight bits of general-purpose vector register vVD. The high-order bits of general-purpose register vVD are replaced with bit seven of the loaded value. The 3-bit P field contains the pipe number which has a value from 0-3. The upper bit of the P field is reserved for future expansion. The G field is used to select one of eight local registers that contains the values for stride, skip, repeat, the vector starting element, and vector length that will be used for this operation. Each pipe has one G register file. A typical implementation of the instruction is:

```
i = 1, j = Starting Element
While (i <= Vector Length)
  if (stride=0, skip=0)
    SRAM EA <- (rB[31:0] + rA[31:0])
    vVD(j)[7:0] <- (SRAM EA)[7:0]
    vVD(j)[15:8] <- (SRAM EA)[7]
  else
    SRAM EA(i) <- (rB[31:0] + rA[31:0]+gG)
    vVD(j)[7:0] <- (SRAM EA)(i)[7:0]
    vVD(j)[15:8] <- (SRAM EA)(i)[7]
  end if
i++, j = (j+1) mod 32;
endwhile
```

The “Vector Load Byte Offset (vlbo)” instruction is shown in FIG. 24. The format of the instruction is:
vlbo vVD,rA,O,P,gG

For this instruction the vector byte data is loaded from the Effective Address (EA) in the SRAM to the specified destination vector register vVD and sign-extended. The 6-bit signed offset is sign-extended and shifted left five bit positions, and then added to the contents of general-purpose register rA to form the effective SRAM address. The 3-bit P field contains the pipe number, which has a value from 0-3. The upper bit of the P field is reserved for future expansion. The G field is used to select one of eight local registers that contains the values for stride, skip, the vector starting element, and vector length that will be used for this operation. Each pipe has one G register file. The EA refers to the SRAM. A typical implementation of the instruction is:

```
i = 1, j = Starting Element
While (i <= Vector Length)
  if (stride=0, skip=0)
  SRAM EA <- (exts(offset)<<5 + rA[31:0])
vVD(j)[7:0] <- (SRAM EA)[7:0]
  vVD(j)[15:8] <- (SRAM EA)[7]
else
  SRAM EA(i) <- (exts(offset)<<5 + rA[31:0]+gG)
vVD(j)[7:0] <- (SRAM EA)(i)[7:0]
  vVD(j)[15:8] <- (SRAM EA)(i)[7]
end if
i++, j = (j+1) mod 32;
endwhile
```

The “Vector Load Doublet Indexed (vldi)” instruction is shown in FIG. 25. The format of the instruction is:
vldi vVD,rA,rB,P,gG

For this instruction the vector data is loaded from the Effective Address (EA) in the SRAM to the specified destination vector register vVD. The index from the contents of general-purpose register rB is added to the contents of general-purpose register rA to form the effective SRAM address. The index (rB) is a signed value, and the base (rA) register is an unsigned value. The byte in the memory as addressed by the EA is loaded into general-purpose vector register vVD. The 3-bit P field contains the pipe number, which has a value from 0-3. The upper bit of the P field is reserved for future expansion. The G field is used to select one of eight local registers that contains the values for stride, skip, the vector starting element, and vector length that will be used for this operation. Each pipe has one G register file. A typical implementation of the instruction is:

```
i = 1, j = Starting Element
While (i <= Vector Length)
  if (stride = 0, skip = 0)
    SRAM EA <- (rB[31:0] + rA[31:0])
    vVD(j)[15:0] <- (SRAM EA)[15:0]
  else
    SRAM EA(i) <- (rB[31:0] + rA[31:0] + gG)
    vVD(j)[15:0] <- (SRAM EA)(i)[15:0]
  end if
i++, j = (j+1) mod 32;
endwhile
```

The “Vector Load Doublet Offset (vldo)” instruction is shown in FIG. 26. The format of the instruction is:
vldo vVD,rA,O,P,gG

For this instruction the vector data is loaded from the Effective Address (EA) in the SRAM to the specified destination vector register vVD. The 6-bit signed offset is sign-extended and shifted left six bit positions, and then added to the contents of general-purpose register rA to form the effective SRAM address. The 3-bit P field contains the pipe number, which has a value from 0-3. The upper bit of the P field is reserved for future expansion. The G field is used to select one of eight local registers that contains the values for stride, skip, the vector starting element, and the vector length that will be used for this operation. Each pipe has one G register file. The EA refers to the SRAM. A typical implementation of the instruction is:

```
i = 1, j = Starting Element
While (i <= Vector Length)
  if (stride=0, skip=0)
  SRAM EA <- (exts(offset)<<6 + rA[31:0])
vVD(j)[15:0] <- (SRAM EA)[15:0]
else
  SRAM EA(i) <- (exts (offset)<<6 + rA[31:0]+gG)
vVD(j)[15:0] <- (SRAM EA)(i)[15:0]
end if
i++, j = (j+1) mod 32;
endwhile
```

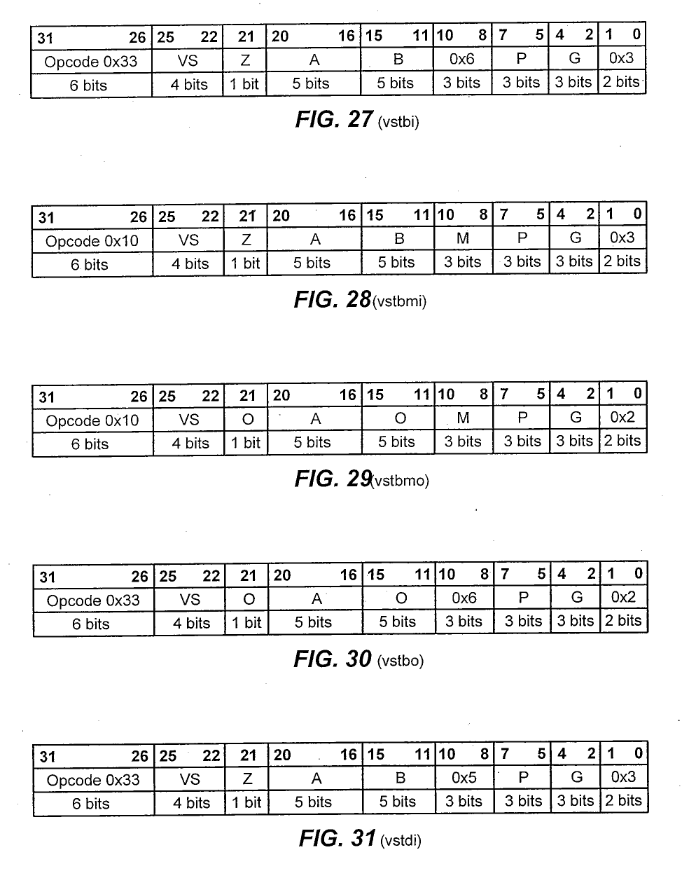

The “Vector Store Byte Indexed (vstbi)” instruction is shown in FIG. 27. The format of the instruction is:
vstbi vVS,rA,rB,P,gG
For this instruction the vector data is sent from the specified vector register vVS to the Effective Address (EA) in the SRAM. The index from the contents of general-purpose register rB is added to the contents of general-purpose register rA to form the effective SRAM address. The 3-bit P field contains the pipe number which has a value from 0-3. the upper bit of the P field is reserved for future expansion. The G field is used to select one of eight local registers that contains the values for stride, skip, the vector starting element, and vector length that will be used for this operation. Each pipe has one G register file. The index (rB) is a signed value, and the base (rA) register is an unsigned value. A typical implementation of the instruction is:
SRAM EA<−(rB[31:0]+rA[31:0]+gG)
SRAM EA [7:0]<−(vVS[7:0])

The “Vector Store Byte Masked Indexed (vstbmi)” instruction is shown in FIG. 28. The format of the instruction is:
vstbmi vVS,rA,rB,mM,P,gG

For this instruction the vector data is sent from the specified vector register vVS to the Effective Address (EA) in the SRAM. The index from the contents of general-purpose register rB is added to the contents of general-purpose register rA to form the effective SRAM address. The value in each element vVS is stored in the effective SRAM address only if the corresponding mask bit for that vector element is set to 1. The 3-bit P field contains the pipe number which has a value from 0-3. the upper bit of the P field is reserved for future expansion. The G field is used to select one of eight local registers that contains the values for stride, skip, repeat, the vector starting element, and vector length that will be used for this operation. Each pipe has one G register file. The index (rB) is a signed value, and the base (rA) register is an unsigned value. A typical implementation of the instruction is:

```
i = 1, j = Starting Element
While (i <= Vector Length)
    SRAM EA(i) <- (rA[31:0]) + (rB[31:0])+ gG
    SRAM EA(i)[7:0]<- (vVS(j)[7:0]) if mM[j]=1
i++, j = (j+1) mod 32;
Endwhile
```

The “Vector Store Byte Masked Offset (vstbmo)” instruction is shown in FIG. 29. The format of the instruction is:
vstbmo vVS,rA,O,mM,P,gG

For this instruction the vector data is sent from the specified vector register vVS to the Effective Address (EA) in the SRAM. The contents of general-purpose register rA are added to the offset to form the effective SRAM address. The value in each element vVS is stored in the effective SRAM address only if the corresponding mask bit for that vector element is set to 1. The 3-bit P field contains the pipe number which has a value from 0-3. The upper bit of the P field is reserved for future expansion. The G field is used to select one of eight local registers that contains the values for stride, skip, repeat, the vector starting element, and vector length that will be used for this operation. Each pipe has one G register file. The Immediate (I) is a signed value, and the base (rA) register is an unsigned value. A typical implementation of the instruction is:

```
i = 1, j = Starting Element
While (i <= Vector Length)
    SRAM EA(i) <- (rA[31:0]) + exts(O[5:0]) << 5 + gG
    SRAM EA(i)[7:0]<- (vVS(j)[7:0]) if mM[j]=1
i++, j = (j+1) mod 32;
endwhile
```

The “Vector Store Byte Offset (vstbo)” instruction is shown in FIG. 30. The format of the instruction is:
vstbo vVS,rA,O,P,gG

For this instruction the vector data is sent from the specified vector register vVS to the Effective Address (EA) in the SRAM. The signed offset is sign-extended, shifted left six bit positions, and added to the contents of general-purpose register rA to form the effective SRAM address. The 3-bit P field contains the pipe number which has a value from 0-3. The upper bit of the P field is reserved for future expansion. The G field is used to select one of eight local registers that contains the values for stride, skip, the vector starting element, and vector length that will be used for this operation. Each pipe has one G register file. The index (rB) is a signed value and the base (rA) register is an unsigned value. A typical implementation of the instruction is:

```
i = 1, j = Starting Element
While (i <= Vector Length)
    SRAM EA[(i) <- (exts O[5:0]<<6 + rA[31:0] + gG)
    SRAM EA[7:0](i) <- (vVS[7:0](j))
i++, j = (j+1) mod 32;
endwhile
```

The “Vector Store Doublet Indexed (vstdi)” instruction is shown in FIG. 31. The format of the instruction is:
vstdi vVS,rA,rB,P,gG

For this instruction the vector data is sent from the specified vector register vVS to the Effective Address (EA) in the SRAM. The index from the contents of general-purpose register rB is added to the contents of general-purpose register rA to form the effective SRAM address. The 3-bit P field contains the pipe number which has a value from 0-3. The upper bit of the P field is reserved for future expansion. The G field is used to select one of eight local registers that contains the values for stride, skip, the vector starting element, and vector length that will be used for this operation. Each pipe has one G register file. The index (rB) is a signed value, and the base (rA) register is an unsigned value. A typical implementation of the instruction is:

```
i = 1, j = Starting Element
While (i <= Vector Length)
    SRAM EA[(i) <- (rB[31:0] + rA[31:0] + gG)
    SRAM EA[15:0](i) <- (vVS[15:0](j))
i++, j = (j+1) mod 32;
endwhile
```

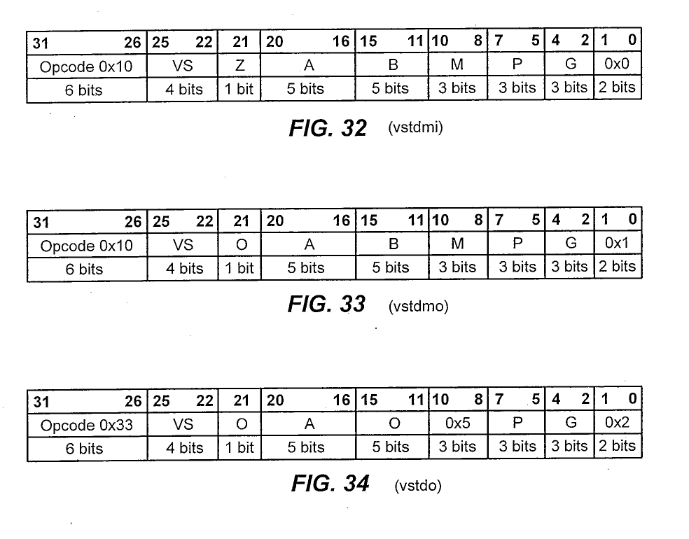

The “Vector Store Doublet Masked Index (vstdmi)” instruction is shown in FIG. 32. The format of the instruction is:
vstdmi vVS,rA,rB,mM,P,gG

For this instruction the vector data is sent from the specified vector register vVS to the Effective Address (EA) in the SRAM. The index from the contents of general-purpose register rB is added to the contents of general-purpose register rA to form the effective SRAM address. The value in each element vVS is stored in the effective SRAM address only if the corresponding mask bit for that vector element is set to 1. The 3-bit P field contains the pipe number which has a value from 0-3. The upper bit of the P field is reserved for future expansion. The G field is used to select one of eight local registers that contains the values for stride, skip, repeat, the vector starting element, and vector length that will be used for this operation. Each pipe has one G register file. The index (rB) is a signed value, and the base (rA) register is an unsigned value. A typical implementation of the instruction is:

i = 1, j = Starting Element
While (i <= Vector Length)
SRAM EA(i) <- (rA[31:0]) + (rB[31:0])+ gG(stride,skip,repeat)
SRAM EA(i)[15:0]<- (vVS(j)[15:0]) if mM[j]=1
i++, j = (j+1) mod 32;
endwhile

The “Vector Store Doublet Masked Offset (vstdmo)” instruction is shown in FIG. 33. The format of the instruction is:
vstdmo vVS,rA,O,mM,P,gG

For this instruction the vector data is sent from the specified vector register vVS to the Effective Address (EA) in the SRAM. The contents of general-purpose register rA are added to the offset to form the effective SRAM address. The value in each element vVS is stored in the effective SRAM address only if the corresponding mask bit for that vector element is set to 1. The 3-bit P field contains the pipe number which has a value from 0-3. The upper bit of the P field is reserved for future expansion. The G field is used to select one of the eight local registers that contains the values for stride, skip, repeat, the vector starting element, and vector length that will be used for this operation. Each pipe has one G register file. The offset (O) is a signed value, and the base (rA) register is an unsigned value. A typical implementation of the instruction is:

```
i = 1, j = Starting Element
While (i <= Vector Length)
    SRAM EA(i) <- (rA[31:0]) + exts(O[5:0]) << 6 +
    gG(stride,skip,repeat)
    SRAM EA(i)[15:0]<- (vVS(j)[15:0]) if mM[j]=1
i++, j = (j+1) mod 32;
endwhile
```

The “Vector Store Doublet Offset (vstdo)” instruction is shown in FIG. 34. The format of the instruction is:
vstdo vVS,rA,O,P,gG

For this instruction the vector data is sent from the specified vector register vVS to the Effective Address (EA) in the SRAM. The 6-bit signed offset is sign-extended, shifted left six bit positions, and added to the contents of general-purpose register rA to form the effective SRAM address. The 3-bit P field contains the pipe number which has a value from 0-3. The upper bit of the P field is reserved for future expansion. The G field is used to select one of eight local registers that contains the values for stride, skip, the vector starting element, and vector length that will be used for this operation. Each pipe has one G register file. The index (rB) is a signed value, and the base (rA) register is an unsigned value. A typical implementation of the instruction is:

```
i = 1, j = Starting Element
While (i <= Vector Length)
    SRAM EA[(i) <- (exts O[5:0]<<6 + rA[31:0] + gG)
    SRAM EA[15:0](i) <- (vVS[15:0](j))
i++, j = (j+1) mod 32;
endwhile
```

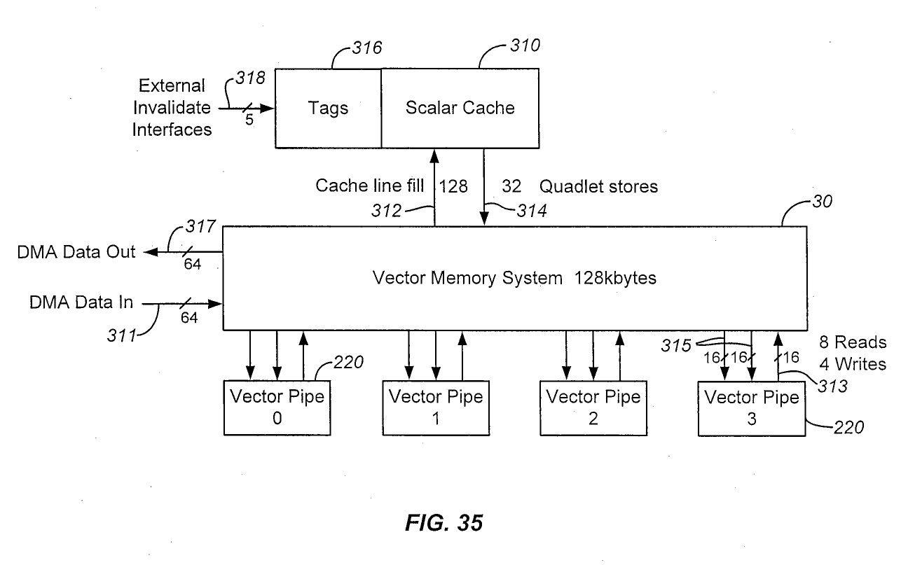

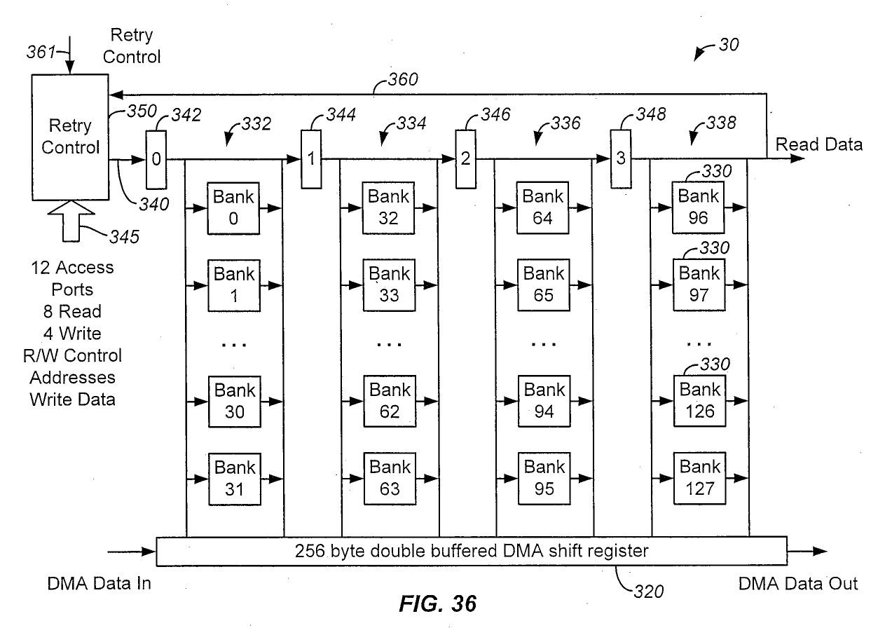

FIG. 35 is a block diagram of a vector memory system according to a preferred embodiment. The vector memory system is coupled to the vector pipes 220 to receives read control information and write control information, as well as address information. Write data is provided over four 16-bit ports 313, read data over eight 16-bit ports 315, and 64 bits are provided for direct memory access (DMA) data input 311 and output 317. Preferably the memory system includes 128 k bytes of memory organized as 128 banks of single ported memory, each one of which is 512 by 16 bits. (This architecture is discussed below in conjunction with FIG. 36.) The DMA bus 311, 317 provides single cycle read and write of 256 bytes and supports doublet reads and doublet writes. Eight read accesses per clock and four write accesses per clock are enabled. The vector memory system has a four clock cycle latency as also discussed below.

The vector memory system is coupled to a scalar cache 310, also implemented as SRAM. The cache interfaces with the vector memory system over two buses, a 128 bit-wide cache line fill bus 312, and a 32 bit-wide quadlet store bus 314. The cache tags 316 are depicted. There are five external invalidate interface buses 318. Scalar cache 310 is a 4 k byte cache which is four-way set associative. It is a write-through cache with 16 byte lines. In FIG. 35 the external invalidate interfaces include DMA write operation to reload the vector memory. The invalidate sources also include a vector store from any of the vector pipes 0-3.

FIG. 36 is a more detailed illustration of the vector memory system 30. As shown there, the memory system includes a 256 byte, double buffered DMA shift register 320 and 128 banks of SRAM memory 330. The banks of memory are arranged as four groups 332, 334, 336, and 338. Each group includes 32 banks of memory. The banks are addressed via a bus 340 with address information supplied over port 345 to retry control 350. The details of the ports and retry control are discussed below. Once the addresses appear on bus 340, however, they pass through a 4-stage pipeline where they are compared with the addresses for each bank. For example, the addresses on bus 340 first passes through stage 342, then second stage 344, then third stage 346, and finally fourth stage 348. If the bank address on bus 340 matches any of the bank addresses in group 332, stage 342 registers the “match” enabling data to be written to or read from the read/write ports of the memory, in a manner explained below. Each bank is addressable by a 7-bit address, with two bits designating the group, and five bits designating the bank within that group. Because the address information arriving on bus 340 may address multiple banks within one group, or even the same bank multiple times, within a given period, a retry control 350 is provided. The retry control enables a subsequent address directed toward the same bank (which is thus not recognized by the downstream address decoding stages 344, 346 and 348) to be fed back via bus 360 to retry control 350. In this manner the same address can be “retried” against the banks a number of times until the access is granted. A retry control line 361 is used to trigger the retry control 350.

The data in the 128 banks of SRAM is loaded and unloaded using a double buffered DMA shift register 320. As will be discussed in more detail below, generally, the shift register is loaded and then its contents transferred out in parallel to a buffer. At an appropriate time during operation of the vector memory system, the 256 bytes are loaded into the 128 banks in parallel.

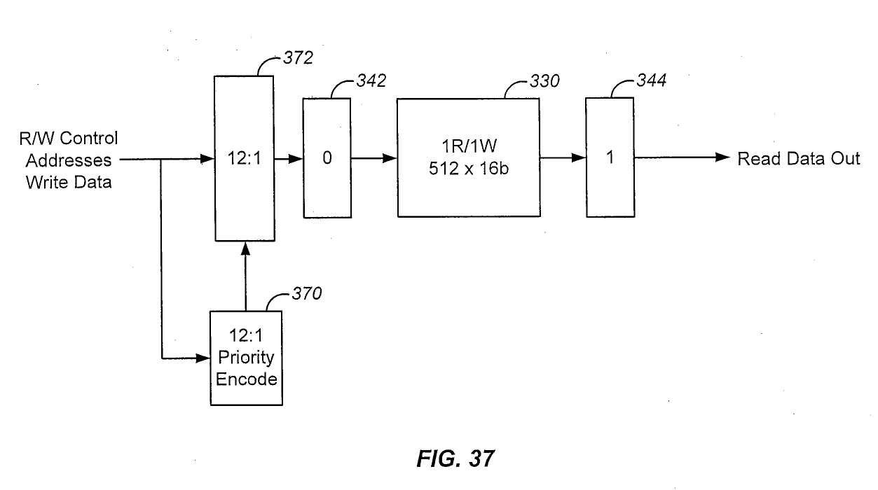

FIG. 37 is a block diagram illustrating in more detail one bank 330 in one group of the 128 banks shown in FIG. 36. As shown by FIG. 37, the bank can receive addresses, write data, and read/write control signals. The signals are decoded by a 12:1 priority encoder 370 using a priority which is discussed below. That circuit enables a 12:1 multiplexer circuit 372 to pass the appropriate information to bank 330.

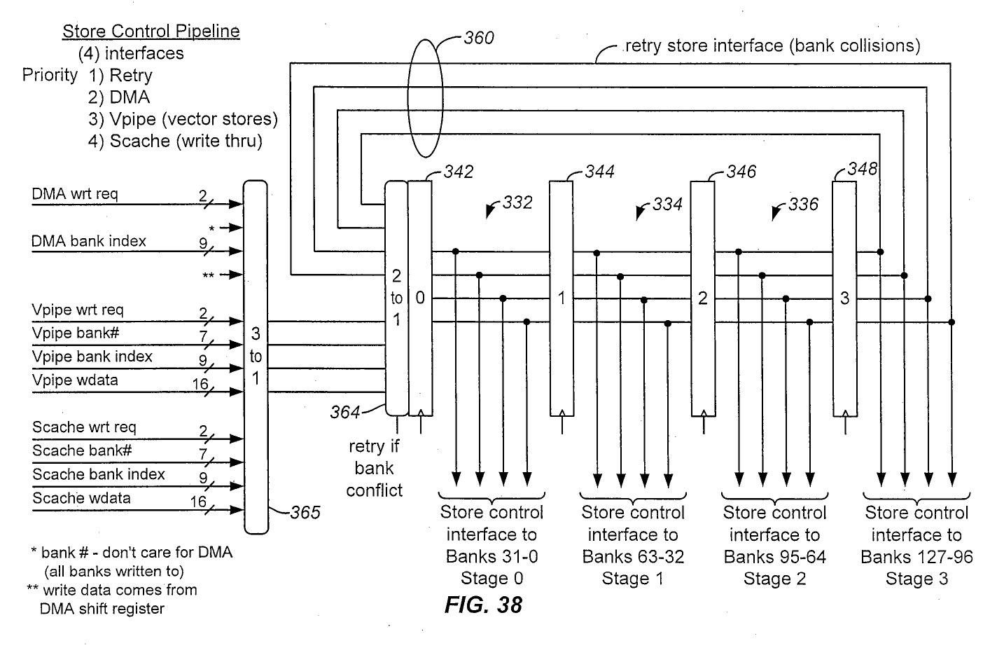

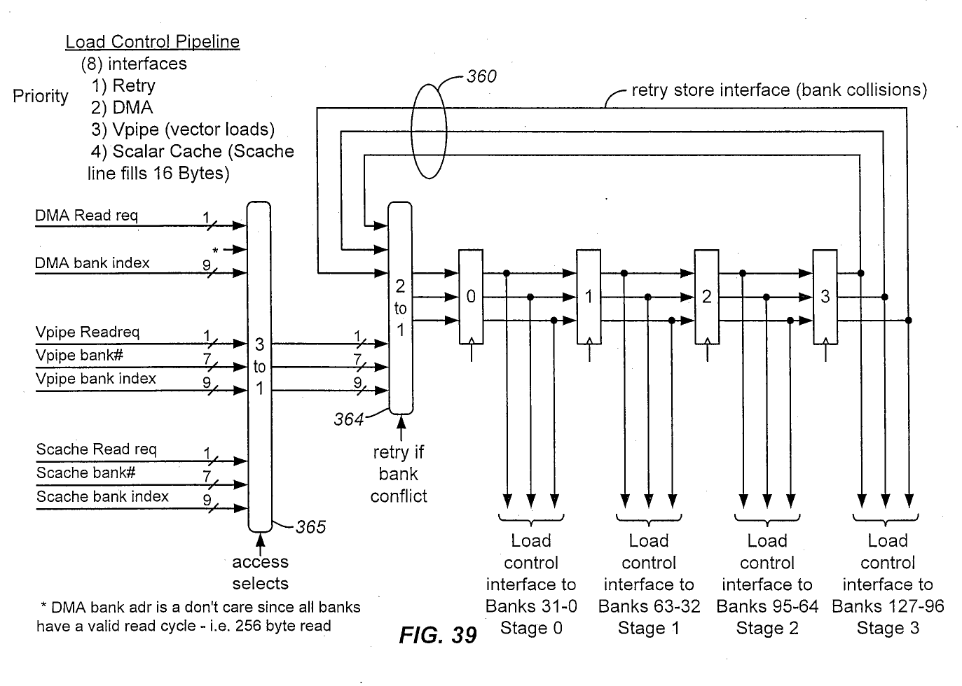

FIGS. 38-45 illustrate the vector memory system in further detail. FIG. 38 illustrates the store control pipeline, and FIG. 39 the load control pipeline, both of which were represented bus 340 in FIG. 36. In FIG. 38 reference numbers have been used corresponding to those in FIG. 36. At the left hand side of FIG. 38 is a 3:1 multiplexer 360 which selects from among three sets of load input signals according to a priority discussed below. The input signals to the multiplexer 360 include DMA write signals, vector pipe write signals, and scalar cache write signals, all as shown. (The 2-bit write request signal (Vpipe WRT REQ) for the vector pipe enables writes for the upper byte, the lower byte, or both bytes.)

Based upon a control signal provided to it, discussed below, multiplexer 360 selects one of these three sets of input data and provides that set of inputs to the multiplexer 364. Multiplexer 364 enables the retry control, and will select the retry bus 360 if there has been a bank conflict or collision in the address information earlier provided, for example, if successive writes are to the same bank. If there has been no bank conflict, then the information from multiplexer 360 is placed on the bus 340 and provided to stage 0 (342) for determination about whether that bank address falls within the group of banks 0-31 in group 332.

The determination of the priority among the three sets of data provided to multiplexer 360 and multiplexer 364 is hardwired. First priority is always given to retrying information from a previous cycle when a bank conflict has occurred. Second priority is assigned to the DMA controller for reloading the banks of memory, as discussed with regard to FIG. 36. Third priority is given to vector store operations, and lowest priority is given to the write through scalar cache. Once the appropriate store control information is placed on bus 340, it is transferred to the banks based upon the bank address in the manner described with respect to FIG. 36.

FIG. 39 is a diagram similar to FIG. 38, but with a load control pipeline instead of the store control pipeline shown in FIG. 38. As shown in FIG. 39, the 3:1 multiplexer 360 receives DMA read requests, vector pipe read requests, and scalar cache read requests, together with associated address information. The selected read signals are provided to the second multiplexer 354 which chooses that selected read signals unless a bank conflict has arisen and a retry is required, all in the same manner as discussed with respect to FIG. 38. The priorities for the load control pipeline in FIG. 39 at multiplexer 360 are the same as in FIG. 38. In particular, read retries have top priority, followed by DMA read access, vector reads, with scalar cache line fills having lowest priority. (If there has been a miss in the scalar cache, the load pipes are used to refill the cache.)

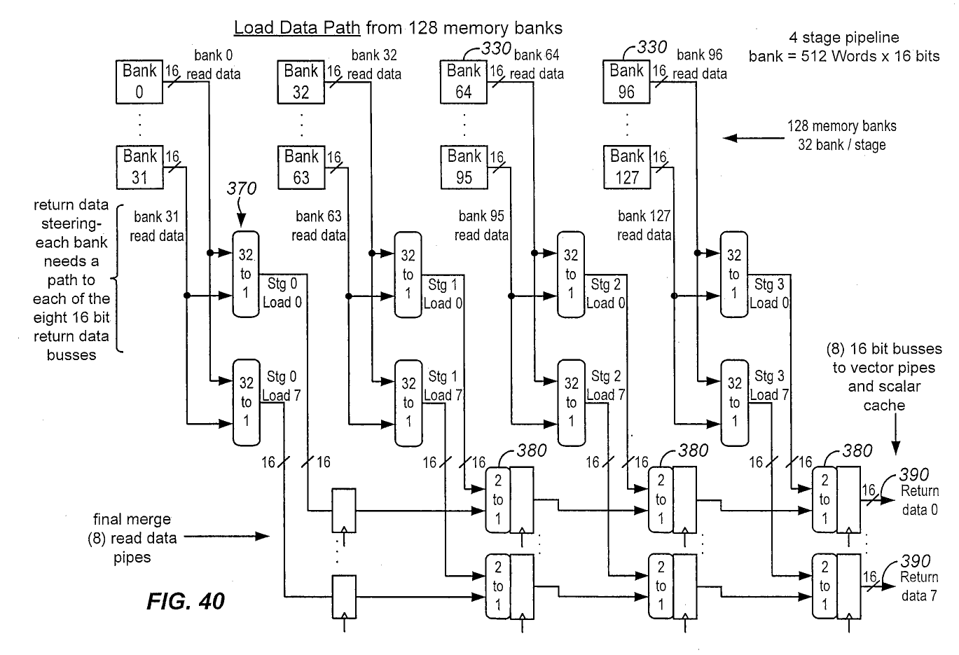

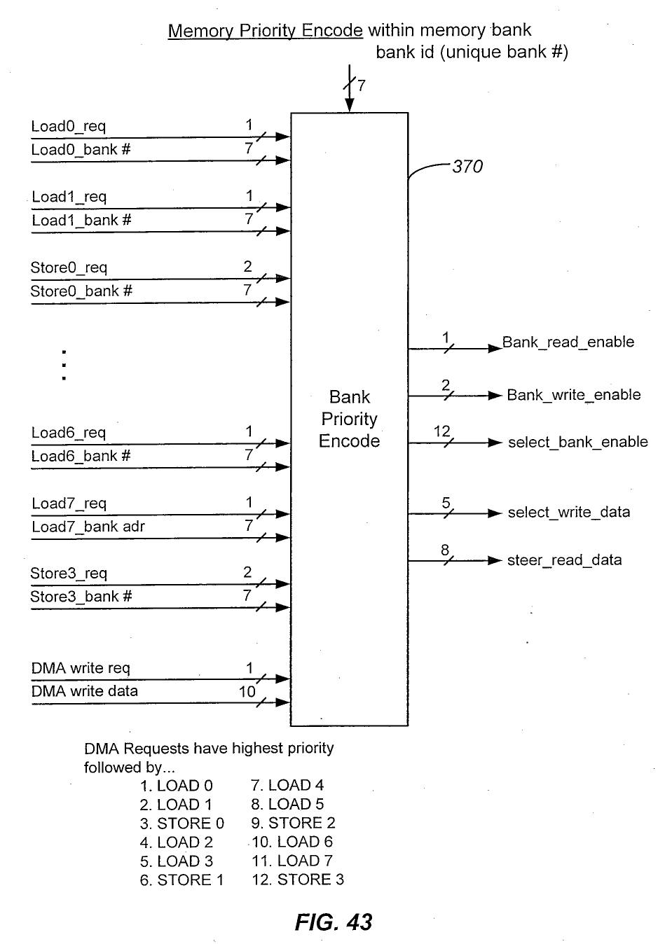

FIG. 40 is a block diagram illustrating in more detail the load data path from the 128 memory banks 330 (first discussed in conjunction with FIG. 36) to the read output terminals. As shown in FIG. 40, for each of the 32 banks in each group of memory, a multiplexer 370 selects which bank has information provided as output data. A series of 2:1 multiplexers, illustrated across the lower portion of FIG. 40, then progressively select between groups which information from which bank and which group will be provided to the output data path. The return data buses 390 are illustrated near the right hand side of the diagram. The multiplexers are controlled by a bank priority encoder which is discussed below in conjunction with FIG. 43.

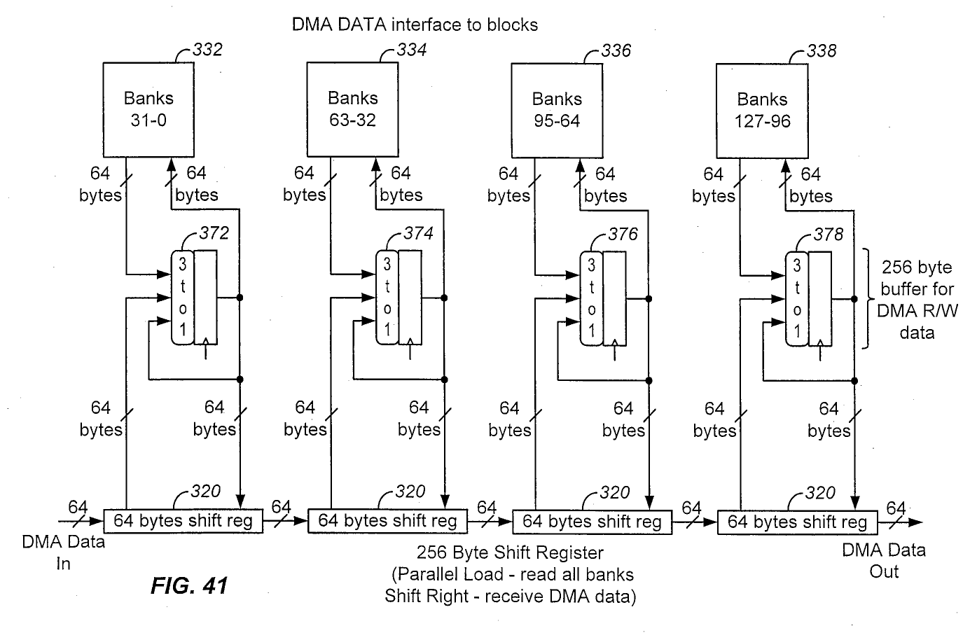

FIG. 41 is a block diagram illustrating how the groups 332, 334, 336, and 338 of bank of memory 330 interface with the DMA shift register. Shift register 320 is illustrated across the lower portion of the diagram. As shown there, the shift register shifts 64 bits at a time to a 256-byte buffer 372, 374, 376, 378 depicted as a flip-flop for DMA read and write data. Each buffer includes a 3:1 multiplexer coupled to the flip-flop to select from data to be written to the banks of memory, data being read from the banks of memory, or data buffered for later writes. The shift register is a parallel load which reads all banks and then shifts them out.

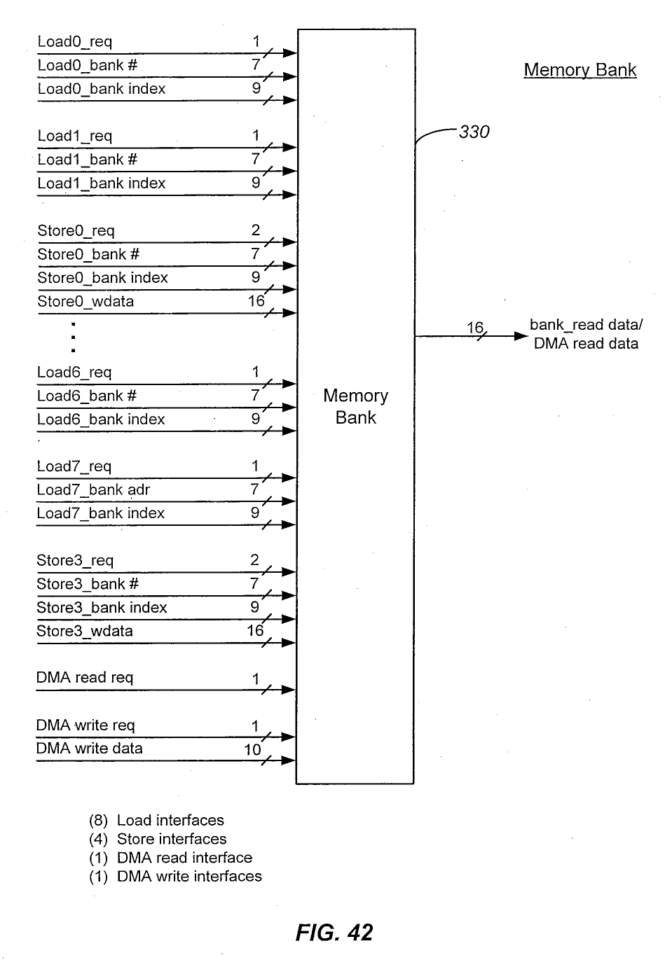

FIG. 42 is a diagram illustrating the input signals provided to one memory bank 330 shown above in other figures. As shown in FIG. 42, the memory bank includes eight load interfaces (designated load 0-load 7), four store interfaces (designated store 0-store 3), one DMA read interface and one DMA write interface. All of these are input signals to the memory bank. The bank output signal consists of a 16-bit read data output.

FIG. 43 is a more detailed description of the bank priority encoder 370 shown in block form in FIG. 37. As shown in FIG. 43, the bank priority encoder 370 receives the load and store requests together with the DMA requests. The particular encoder is selected by the bank ID. Among all of the groups of input signals, DMA requests have the highest priority, followed by the priorities in the order listed at the lower portion of the figure. The output from the bank priority encoder includes bank read and bank write enable signals, select bank index signals, select write data signals, and steer read data signals.

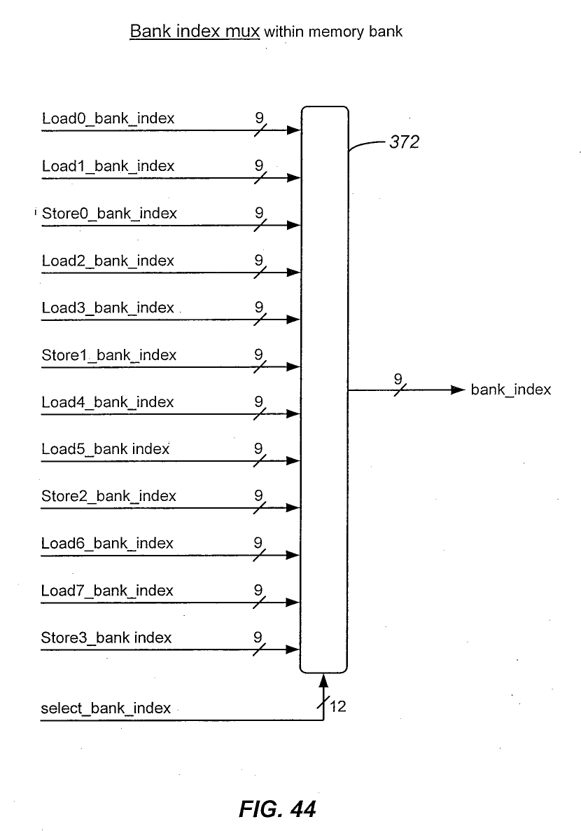

FIG. 44 is a block diagram illustrating details of the bank index multiplexer 372 within a memory bank. This multiplexer was illustrated in block form in as multiplexer 372 in FIG. 37. As shown in FIG. 44, the index multiplexer 372 receives load and store bank index signals for all eight load buses and four store buses. A select bank index control signal selects the 9-bit output signal providing the bank index.

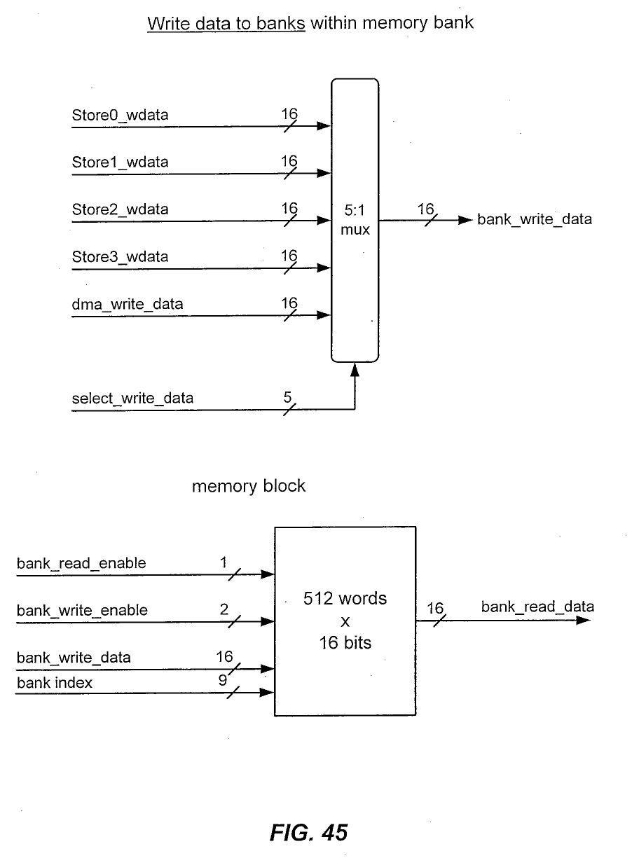

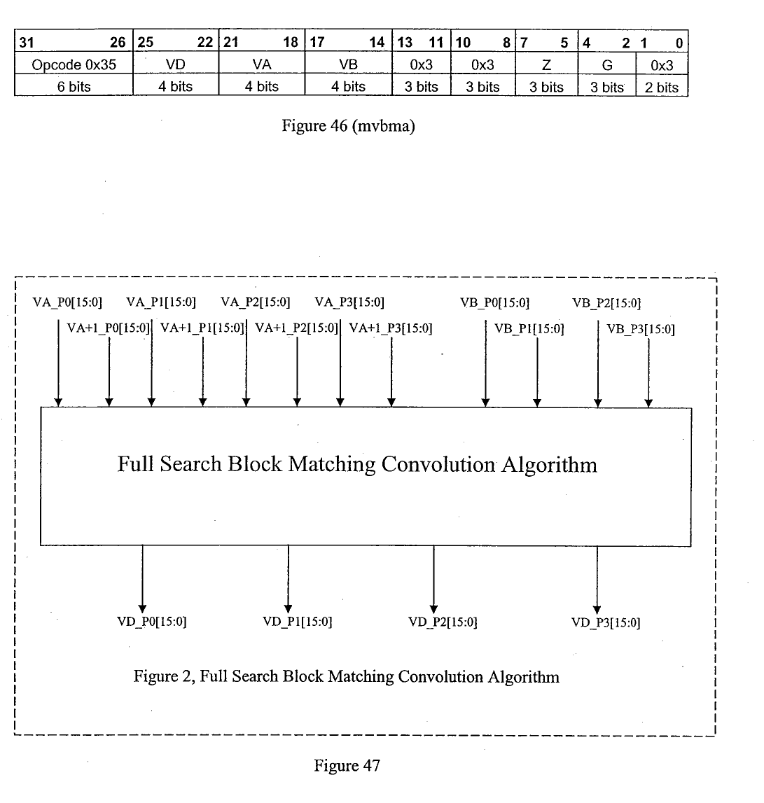

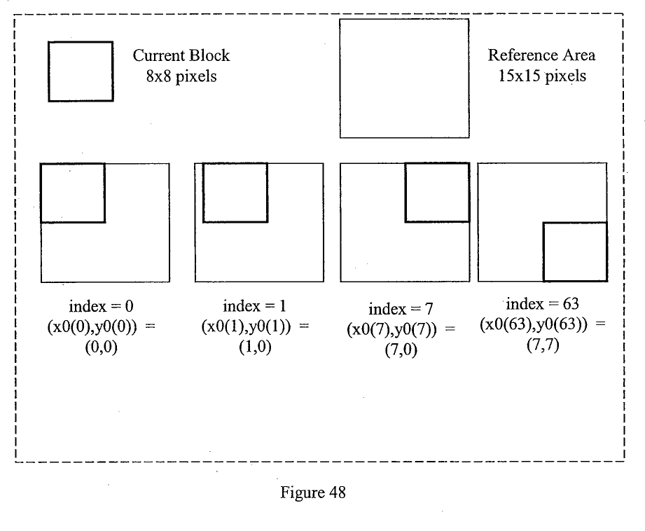

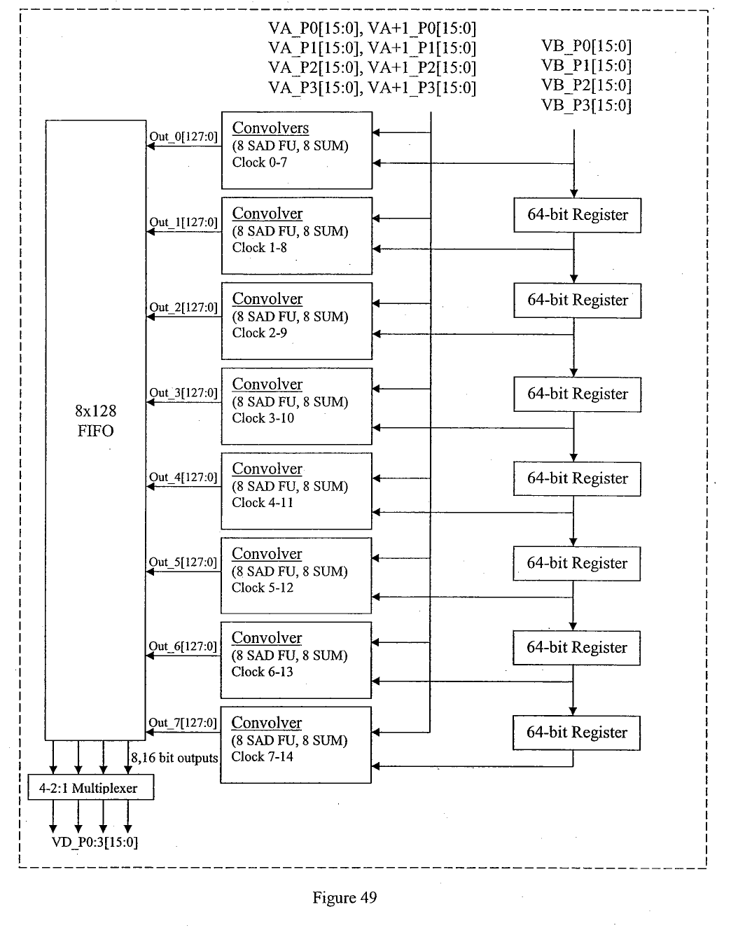

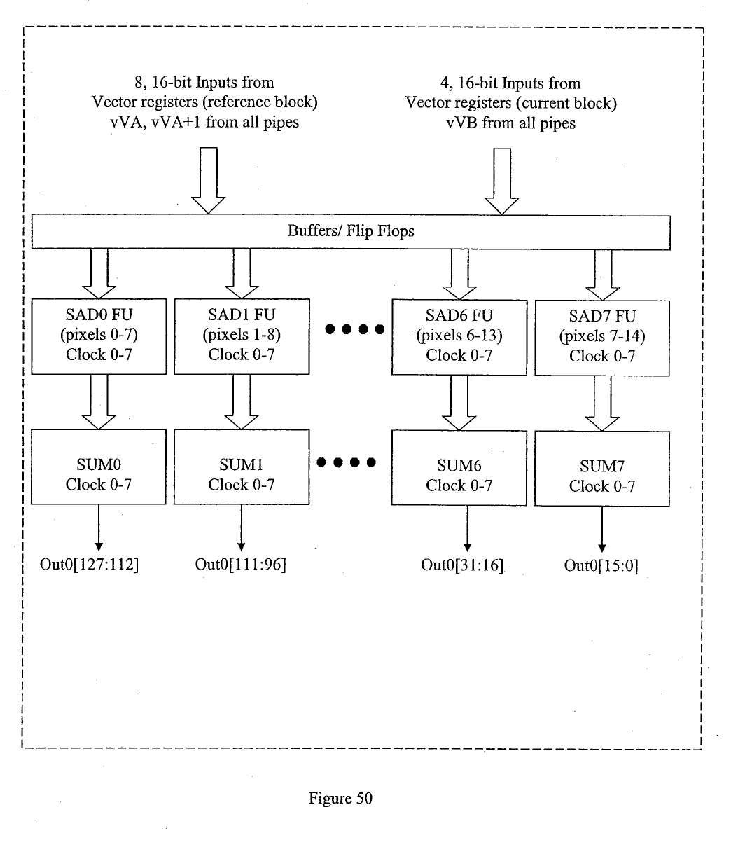

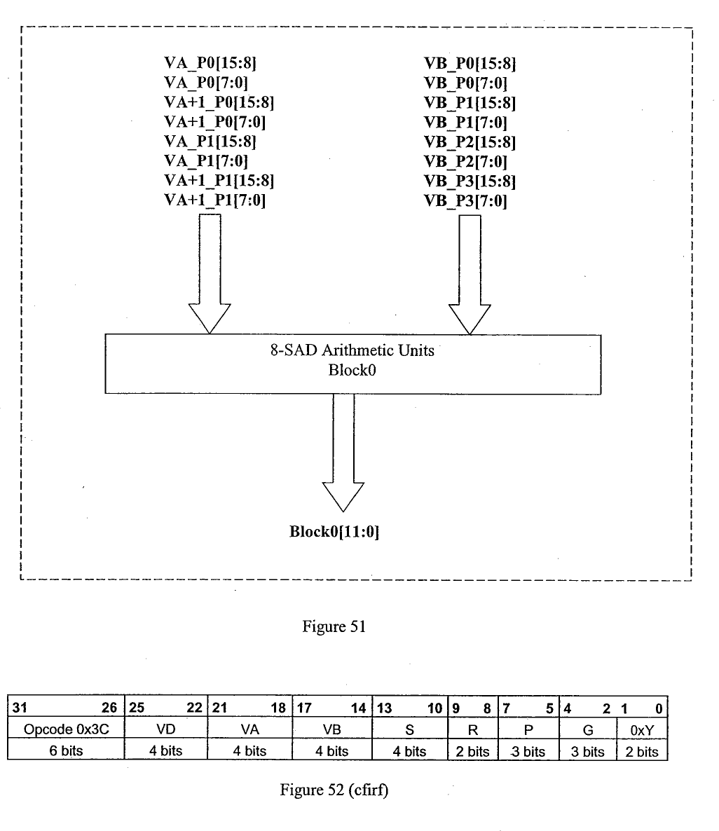

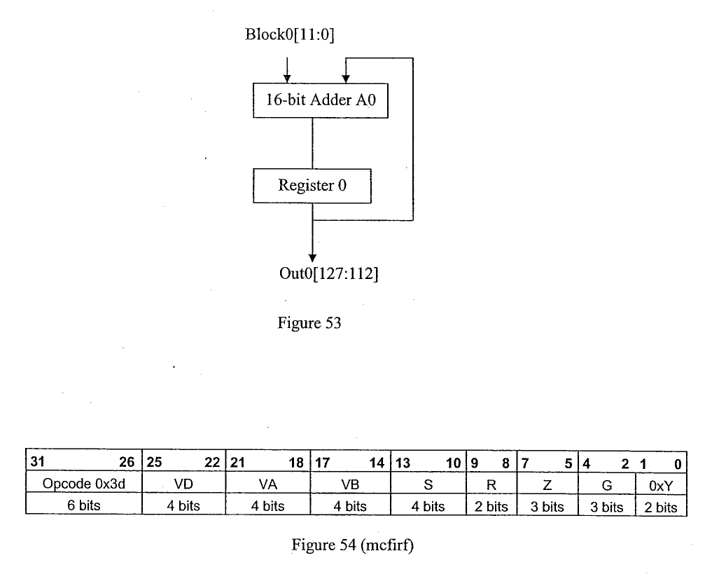

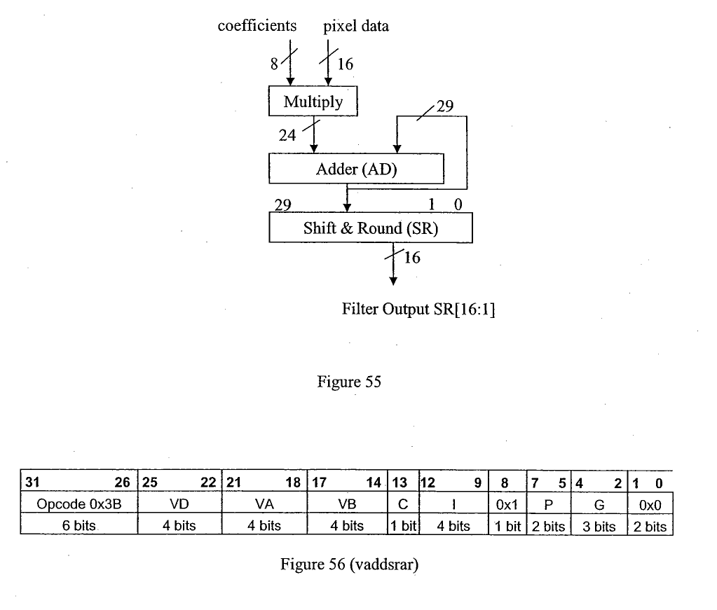

In the upper portion, FIG. 45 illustrates the 5:1 multiplexer for selecting the write data for a particular bank. As shown there, the four store buses and the DMA write bus are provided as inputs to the multiplexer. The select write data signal choosing one of the five to thereby provide a bank write data output. In the lower portion of FIG. 45, the particular input and output signals for the memory cells themselves are illustrated. These include the bank read enable, bank write enables (for upper and lower bytes), the bank write data and the bank index. The output from the SRAM consists of the bank read data signals.

The “Multi-Pipe Vector Block Matching Instruction (mvbma)” instruction is shown in FIG. 46. The format of that instruction is:
mvbma vVD,vVA,vVB,gG
The mvbma instruction performs a full search block matching operation between the pixel data of a current image block, typically 8×8 pixels, stored in the vector registers vVB and a reference area of the image data, typically 15×15 pixels, stored in vector registers vVA and vVA+1. (Because there is not enough space in the instruction format, register vVA+1 is defined as the next register in the set and is utilized in this manner.)

Both the reference area and current block are stored in vector registers and packed as two pixels per vector register element, each expressed as an 8-bit unsigned value. For execution of the instruction, a fixed vector length of 15 is set in field gG[47:42], and the starting element must be zero. Other numbers produce undefined results. For this instruction, the selected G register file in each pipe must be identical. The reference image data is loaded from sixteen vector registers, vVA and vVA+1 from each of the four pipes. This instruction operates as a multi-pipe instruction. The results of the block matching operation for each block match are stored in registers vVD as described below.

FIG. 47 illustrates the instruction in block form showing the input information from registers vVA, vVA+1, and vVB. Also shown is the result of the instruction being stored in registers vVD. Sixteen bits of information from vector register VA_P0 register (register vVA for pipe 0), from registers vVA for each of pipes 1-3, from registers vVA+1 for pipes 0-3, and from registers vVB for each of pipes 0-3 are provided. In response output information is stored in registers vVD for each of pipes 0-3.

In this instruction, a sum of absolute (SAD) pixel differences is used as the block matching criterion. In this operation, pixels are compared in two images—the current block of pixels and the reference block of pixels—one by one, their difference, e.g. gray level, is calculated and a sum over all differences is returned. Of course other comparison operations may also be used. In implementing the operation, a block comparison of an 8×8 pixel current block stored in register vVB with respect to a reference area of 15×15 pixels stored in vVA and vVA+1 is performed. After a comparison is made at index 0, the current block is shifted one pixel column to the right and a new comparison performed against the reference block at index 1 in the same manner as just described, i.e. for all 64 pixels of the current block. After this comparison, the current block is “moved,” and again compared to the reference block. This process of comparing and shifting is repeated until all of index locations 0-63 have SADs computed and stored in register vVD.

The general approach for determining matching of the current block to the reference block, as well as an index to identify the relative position of the current block with respect to the reference block, for various block comparison locations, is shown in FIG. 48. As shown there, the first pixel line of 8 pixels in the current block is compared with the first 8 pixels of the first line of the reference area. The SAD operation is performed on each of the eight pixel pairs and added together to form one number. Over the next seven clock periods, each line in the current block, and each line in the reference block has its SAD computed and summed with the previous result. After all eight partial results are generated, they are added together to produce one final result, which is stored back into vector register vVD.

The operation just described is considered the result for one comparison. There are 64 locations to compare an 8×8 current block of pixels with the 15×15 pixel reference area, and thus there are 64 search locations. For each search location, the SAD of the current block with respect to the reference area at that location is computed and returned to vector registers VD0, VD1, VD2 and VD3.

This instruction requires 15 clock periods to retrieve the reference and current block data from the vector registers. Storing of the results requires 16 clock periods, but cannot start until clock period 8, resulting in a total latency of 24 clocks. The final 8 clocks for storing, however, can be overlapped with the next instruction, yielding an average latency of 16 clock periods. With a reference size of 15×15 the total number of SADs is computed in 24 clocks: ((8×8)×(8×8))/16=256 SADs per clock which results in 192 GigaSAD/sec/vector processor (256*750 MHz).

FIG. 49 is a detailed block diagram for implementing the mvbma instruction. The convolver at the top of the block diagram performs the block matching operation comparing the current block stored in the vVB registers with the reference block stored in the vVA and vVA+1 registers for index locations 0-7 producing a total of eight results.

The second convolver performs the 64 pixel comparisons for each of the eight index locations 8-15; the third convolver for index locations 16-23, etc. Note that the clock periods for the operations are offset by one clock for each subsequent convolver, i.e. the convolvers operate on Clock0-7, Clock1-8, Clock2-9, Clock3-10, Clock4-11, Clock5-12, Clock6-13, Clock7-14. A series of 64 bit registers along the right side of FIG. 49 delay the data from registers vVB (the current block of pixel data) as it is passed to subsequent convolvers. By pipelining the current block (VB) through the series of 64 bit registers, the first pixel line of the current block is compared (SAD) with the nth line of the reference block. In effect the current block is slid past the reference block in both the vertical as well as the horizontal directions, providing a two dimensional convolver. There are eight 16-bit results from each convolver after the first eight clock periods. Thereafter, eight results are generated every clock for eight clocks. Only four 16-bit results can be stored in the vector registers on each clock period using all four pipes, and the first-in first-out (FIFO) memory buffers the results as needed.

As shown in FIG. 49, once the convolvers complete their respective calculations, the output data is loaded into the FIFO to buffer the results to enable the results to be written out at a different speed than the speed of operation of the convolvers. The convolvers are faster than the write operation to the vVD registers. The multiplexer is used to select among the eight, 16 bit outputs to provide the four, 16 bit inputs to the vVD registers.

FIG. 50 illustrates the internal structure of one convolver. Each of the eight SAD functional units labeled SAD0, SAD1 . . . SAD7, SAD8 performs SAD operations on the following pixel groups, pixels 0-7 of the current block and the following reference pixel groups:
Block0=pixel 0-7
Block1=pixel 1-8
Block2=pixel 2-9
Block3=pixel 3-10
Block4=pixel 4-11
Block5=pixel 5-12
Block6=pixel 6-13
Block7=pixel 7-14
Each of the blocks are overlapped by 7 pixels and shifted to the right by one pixel, hence the convolution. Thus Block0 computes the SAD horizontally on 8 pixels starting with pixel 0. Block 1 computes the SAD horizontally on 8 pixels starting with pixel 1 and so forth. The SAD calculations from each functional unit are then provided to corresponding adders SUM0, SUM1, . . . which compute the sums of the results of the SAD operations, ultimately providing those sums as output signals (to the FIFO shown in FIG. 49).

FIG. 51 shows how the vector register bits are mapped to perform a convolution operation in the X direction. Each Block computes the SAD horizontally on eight pixels at one time as described above. After eight clocks a total of eight results will have been generated.

The equations below describe how all of the inputs from the vector registers compute the SAD horizontally on eight bits. For example the Sum of Absolute Differences is described as follows: |(VA_P0[15:8])−(VB_P0[15:8])|, here the absolute value is taken for the difference between vVA and vVB pixels.

8 SAD Arithmetic Units
SAD00[8:0]=|(VA_{—}P0[15:8])−(VB_{—}P0[15:8])|
SAD01[8:0]=|(VA_{—}P0[7:0])−(VB_{—}P0[7:0])|
SAD02[8:0]=|(VA+1_{—}P0[15:8])−(VB_{—}P1[15:8])|
SAD03[8:0]=|(VA+1_{—}P0[7:0])−(VB_{—}P1[7:0])|
SAD04[8:0]=|(VA_{—}P1[15:8])−(VB_{—}P2[15:8])|
SAD05[8:0]=|(VA_{—}P1[7:0])−(VB_{—}P2[7:0])|
SAD06[8:0]=|(VA+1_{—}P1[15:8])−(VB_{—}P3[15:8])|
SAD07[8:0]=|(VA+1_{—}P1[7:0])−(VB_{—}P3[7:0])|
Block0[11:0]=SAD00[8:0]+SAD01[8:0]+SAD02[8:0]+SAD03[8:0]+SAD04[8:0]+SAD05[8:0]+SAD06[8:0]+SAD07[8:0]
SAD11[8:0]=|(VA_{—}P0[7:0])−(VB_{—}P0[15:8])|
SAD12[8:0]=|(VA+1_{—}P0[15:8])−(VB_{—}P0[7:0])|
SAD13[8:0]=|(VA+1_{—}P0[7:0])−(VB_{—}P1[15:8])|
SAD14[8:0]=|(VA_{—}P1[15:8])−(VB_{—}P1[7:0])|
SAD15[8:0]=|(VA_{—}P1[7:0])−(VB_{—}P2[15:8])|
SAD16[8:0]=|(VA+1_{—}P1[15:8])−(VB_{—}P2[7:0])|
SAD17[8:0]=|(VA+1_{—}P1[7:0])−(VB_{—}P3[15:8])|
SAD18[8:0]=|(VA_{—}P2[15:8])−(VB_{—}P3[7:0])|
Block1[11:0]=SAD11[8:0]+SAD12[8:0]+SAD13[8:0]+SAD14[8:0]+SAD15[8:0]+SAD16[8:0]+SAD17[8:0]]+SAD18[8:0]
SAD22[8:0]=|(VA+1_{—}P0[15:8])−(VB_{—}P0[15:8])|
SAD23[8:0]=|(VA+1_{—}P0[7:0])−(VB_{—}P0[7:0])|
SAD24[8:0]=|(VA_{—}P1[15:8])−(VB_{—}P1[15:8])|
SAD25[8:0]=|(VA_{—}P1[7:0])−(VB_{—}P1[7:0])|
SAD26[8:0]=(VA+1_{—}P1[15:8])−(VB_{—}P2[15:8])|
SAD27[8:0]=|(VA+1_{—}P1[7:0])−(VB_{—}P2[7:0])|
SAD28[8:0]=|(VA_{—}P2[15:8])−(VB_{—}P3[15:8])|
SAD29[8:0]=|(VA_{—}P2[7:0])−(VB_{—}P3[7:01)|
Block2[11:0]=SAD22[8:0]+SAD23[8:0]+SAD24[8:0]+SAD25[8:0]+SAD26[8:0]+SAD27[8:0]]+SAD28[8:0]+SAD29[8:0]
SAD33[8:0]=|(VA+1_{—}P0[7:0])−(VB_{—}P0[15:8])|
SAD34[8:0]=|(VA_{—}P1[15:8])−(VB_{—}P0[7:0])|
SAD35[8:0]=|(VA_{—}P1[7:0])−(VB_{—}P1[15:8])|
SAD36[8:0]=|(VA+1_{—}P1[15:8])−(VB_{—}P1[7:0])|
SAD37[8:0]=|(VA+1_{—}P1[7:0])−(VB_{—}P2[15:8])|
SAD38[8:0]=|(VA_{—}P2[15:8])−(VB_{—}P2[7:0])|
SAD39[8:0]=|(VA_{—}P2[7:0])−(VB_{—}P3[15:8])|
SAD310[8:0]=|(VA_{—}+1P2[15:8])−(VB_{—}P3[7:0])|
Block3[11:0]=SAD33[8:0]+SAD34[8:0]+SAD35[8:0]+SAD36[8:0]+SAD37[8:0]]+SAD38[8:0] SAD39[8:0]+SAD310[8:0]
SAD44[8:0]=|(VA_{—}P1[15:8])−(VB_{—}P0[15:8])|
SAD45[8:0]=|(VA_{—}P1[7:0])−(VB_{—}P0[7:0])|
SAD46[8:0]=|(VA+1_{—}P1[15:8])−(VB_{—}P1[15:8])|
SAD47[8:0]=|(VA+1_{—}P1[7:0])−(VB_{—}P1[7:0])|
SAD48[8:0]=|(VA_{—}P2[15:8])−(VB_{—}P2[15:8])|
SAD49[8:0]=|(VA_{—}P2[7:0])−(VB_{—}P2[7:0])|
SAD410[8:0]=|(VA_{—}+1P2[15:8])−(VB_{—}P3[15:8])|
SAD411[8:0]=|(VA_{—+}1P2[7:0])−(VB_{—}P3[7:0])|
Block4[11:0]=SAD44[8:0]+SAD45[8:0]+SAD46[8:0]+SAD47[8:0]]+SAD48[8:0]+SAD49[8:0]+SAD410[8:0]+SAD411[8:0]
SAD55[8:0]=|(VA_{—}P1[7:0])−(VB_{—}P0[15:8])|
SAD56[8:0]=|(VA+1_{—}P1[15:8])−(VB_{—}P0[7:0])|
SAD57[8:0]=|(VA+1_{—}P1[7:0])−(VB_{—}P1[15:8])|
SAD58[8:0]=|(VA_{—}P2[15:8])−(VB_{—}P1[7:0])|
SAD59[8:0]=|(VA_{—}P2[7:0])−(VB_{—}P2[15:8])|
SAD510[8:0]=|(VA_{—}+1P2[15:8])−(VB_{—}P2[7:0])|
SAD511[8:0]=|(VA_{—+}1P2[7:0])−(VB_{—}P3[15:8])|
SAD512[8:0]=|(VA_{—}P3[15:8])−(VB_{—}P3[7:0])|
Block5[11:0]=SAD55[8:0]+SAD56[8:0]+SAD57[8:0]]+SAD58[8:0]+SAD59[8:0]+SAD510[8:0]+SAD511[8:0]+SAD512[8:0]
SAD66[8:0]=(VA+1_{—}P1[15:8])−(VB_{—}P0[15:8])|
SAD67[8:0]=|(VA+1_{—}P1[7:0])−(VB_{—}P0[7:0])|
SAD68[8:0]=|(VA_{—}P2[15:8])−(VB_{—}P1[15:8])|
SAD69[8:0]=|(VA_{—}P2[7:0])−(VB_{—}P1[7:0])|
SAD610[8:0]=|(VA_{—}+1P2[15:8])−(VB_{—}P2[15:8])|
SAD611[8:0]=|(VA_{—}+1P2[7:0])−(VB_{—}P2[7:0])|
SAD612[8:0]=|(VA_{—}P3[15:8])−(VB_{—}P3[15:8])|
SAD613[8:0]=|(VA_{—}P3[7:0])−(VB_{—}P3[7:0])|
Block6[11:0]=SAD66[8:0]+SAD67[8:0]]+SAD68[8:0]+SAD69[8:0]+SAD610[8:0]+SAD611[8:0]+SAD612[8:0]+SAD613[8:0]
SAD77[8:0]=|(VA+1_{—}P1[7:0])−(VB_{—}P0[15:8])|
SAD78[8:0]=|(VA_{—}P2[15:8])−(VB_{—}P0[7:0])|
SAD79[8:0]=|(VA_{—}P2[7:0])−(VB_{—}P1[15:8])|
SAD710[8:0]=|(VA_{—}+1P2[15:8])−(VB_{—}P1[7:0])|
SAD711[8:0]=|(VA_{—}+1P2[7:0])−(VB_{—}P2[15:8])|
SAD712[8:0]=|(VA_{—}P3[15:8])−(VB_{—}P2[7:0])|
SAD713[8:0]=|(VA_{—}P3[7:0])−(VB_{—}P3[15:8])|
SAD714[8:0]=|(VA+1_{—}P3[15:8])−(VB_{—}P3[7:0])|
Block7[11:0]=SAD77[8:0]]+SAD78[8:0]+SAD79[8:0]+SAD710[8:0]+SAD711[8:0]+SAD712[8:0]+SAD713[8:0]+SAD714[8:0]
Another instruction for the vector processor is described next.

The “Convolution FIR Filter (cfirf)” instruction is shown in FIG. 52. The format of the instruction is:
cfirf vVD,vVA,vVB,S,R,P,gG,Y

This format defines a three convolution finite impulse response (FIR) filter instruction. The format allows the selection of a 4, 5 or 6 tap filter to be performed on the vVA register by the Y field bits [1:0]. Each of the instructions performs a convolution FIR filter with data in the vVA vector register and up to six 8-bit signed coefficients, stored in the vVB vector register. Each coefficient is loaded into bits [7:0] of the vector register, with coefficient 0 in element 0 and coefficient 5 in element 5.

The vector register specified by the vVA field has one 16-bit signed pixel in each element of the register. There are six MAC units in this functional unit and each MAC unit is shown in FIG. 53. Each of these MAC units can perform a 4, 5, or 6 tap FIR filter.

The adder in each of the filters can perform rounding and saturating adds as a function of the R bits[9:8] of the immediate field. The saturating add forces all “ones” when an overflow occurs on an a positive number. If the result of the adder is a negative number the adder is forced to all “zero's”. The final result can be shifted in accordance with the immediate field S [13:10] controls.

Bits [16:1] of the shift and round unit are selected and transferred to the register vVD as shown in Table 6. Table 5 shows which MAC unit is operating on specific elements of the vVA register. For example, for a 6 tap filter, MAC unit 0 operates on doublet [15:0] of elements 0, 1, 2, 3, 4, and 5 in the vVA register and produces one 16-bit result. MAC unit 0 then operates on elements 6, 7, 8, 9, 10, and 11, and produces another result. Selecting a 4 tap filter allows 28 filters in 31 clocks, while a 5 tap filter will allow 25 filters in 29 clocks. A 6 tap filter allows 24 filters in 29 clocks. The results of a 6 tap filter are placed in the vVD vector register as shown in Table 6, other filters have similar repeating output characteristics. The vector pipe is selected by the 3-bit P field. The G field selects the register containing the starting element, which must be zero and the vector length as specified in Table 5.
Number of taps=Y[1:0] (16-bit signed input and output)
0x0=4 taps,
0x1=5 taps,
0x2=6 taps,
0x3=6 taps, used for 16x16 Macroblock
Shift count=(Arithmetic Right Shift) S[13:10]
0x0=no shift
0x1=1, 0x2=2, 0x3=3, 0x4=4, 0x5=5, 0x6=6, 0x7=7, 0x8=8
0x9=9, 0xA=10, 0xB=11, 0xC=12, 0xD=13, 0xE=14, 0xF=15
Round=R[9:8]
0x0=no round
0x1=round and no saturation
0x2=round with 8-bit saturation
0x0=round with 16-bit saturation

TABLE 5
MAC Units

| Y[1:0] | MAC0 | MAC1 | MAC2 | MAC3 | MAC4 | MAC5 | VL |
|---|---|---|---|---|---|---|---|
| 0x3 | 0-5 | 1-6 | 2-7 | 3-8 | 4-9 | 5-10 | 21 |
| | 6-11 | 7-12 | 8-13 | 9-14 | 10-15 | 11-16 | |
| | 12-17 | 13-18 | 14-19 | 15-20 | | | |
| 0x2 | 0-5 | 1-6 | 2-7 | 3-8 | 4-9 | 5-10 | 29 |
| | 6-11 | 7-12 | 8-13 | 9-14 | 10-15 | 11-16 | |
| | 12-17 | 13-18 | 14-19 | 15-20 | 16-21 | 17-22 | |
| | 18-23 | 19-24 | 20-25 | 21-26 | 22-27 | 23-28 | |
| 0x1 | 0-4 | 1-5 | 2-6 | 3-7 | 4-8 | NA | 29 |
| | 5-9 | 6-10 | 7-11 | 8-12 | 9-13 | | |
| | 10-14 | 11-15 | 12-16 | 13-17 | 14-18 | | |
| | 15-19 | 16-20 | 17-21 | 18-22 | 19-23 | | |
| | 20-24 | 21-25 | 22-26 | 23-27 | 24-28 | | |
| 0x0 | 0-3 | 1-4 | 2-5 | 3-6 | NA | NA | 31 |
| | 4-7 | 5-8 | 6-9 | 7-10 | | | |
| | 8-11 | 9-12 | 10-13 | 11-13 | | | |
| | 12-15 | 13-16 | 14-17 | 15-18 | | | |
| | 16-19 | 17-20 | 18-21 | 19-22 | | | |
| | 20-23 | 21-24 | 22-25 | 23-26 | | | |
| | 24-27 | 25-28 | 26-29 | 27-30 | | | |

TABLE 6

| vVD | MAC Unit |
|---|---|
| Element | Output |
| 0 | MAC0 |
| 1 | MAC1 |
| 2 | MAC2 |
| 3 | MAC3 |
| 4 | MAC4 |
| 5 | MAC5 |
| 6 | MAC0 |
| 7 | MAC1 |
| 8 | MAC2 |
| 9 | MAC3 |
| 10 | MAC4 |
| 11 | MAC5 |
| 12 | MAC0 |
| 13 | MAC1 |
| 14 | MAC2 |
| 15 | MAC3 |
| 16 | MAC4 |
| 17 | MAC5 |
| 18 | MAC0 |
| 19 | MAC1 |
| 20 | MAC2 |
| 21 | MAC3 |
| 22 | MAC4 |
| 23 | MAC5 |
| 24 | MAC0 |
| 25 | MAC1 |
| 26 | MAC2 |
| 27 | MAC3 |
| 28 | MAC4 |
| 29 | MAC5 |
| 30 | |
| 31 | |

A typical implementation of the instruction (for shifting and rounding of MAC units) is:

```
    SR[29:1] <--- AD[28:0]
    SR[0] <-- 0
    SR[29:0] <--- SR[29:0] >> S[13:10] //shift count, sign extended shift
if R[9:8]=0x0  //no rounding
    vVD[15:0] <-- SR[16:1]
    if R[9:8]=0x1  //Round & No Saturation
    SR[29:0] <-- SR[29:0]+1
    vVD[15:0] <-- SR[16:1]
else //R[9:8]=0x2  // Round & Saturate 0xFF<=X>=0x00
    SR[29:0] <-- SR[29:0]+1
```

| | |
|---|---|
| If | SR[29] = 1 |
| | SR[16:1] <-- 0x0000 |
| If | SR[19] = 0 and SR[18:9] !=0 |
| | SR[16:1] <-- 0xFFFF |
| | SR[16:1] <-- SR[16:1] |

```
    end if
    vVD[15:0] <-- SR[16:1]
```

The “Multi-Pipe Convolution FIR Filter (mcfirf)” instruction is shown in FIG. 54. The format of the instruction is:
mcfirf vVD,vVA,vVB,S,R,gG,Y

Like the cfirf instruction, this format defines three convolution FIR filter instructions. The format allows the selection of a 4, 5 or 6 tap filter to be performed on the vVA register by the Y field bits [1:0]. Each of the instructions performs a convolution FIR filter with data in the vVA vector register and up to six 8-bit signed coefficients, stored in the vVB vector register. Each coefficient is loaded into bits [7:0] of the vector register, with coefficient 0 in element 0 and coefficient 5 in element 5.

The vector register specified by the vVA field has one 16-bit signed pixel in each element of the register. There are six MAC units in this functional unit and each MAC unit is shown in FIG. 53. Each of these MAC units can perform a 4, 5, or 6 tap FIR filter.

The adder in each of the filters can perform rounding and saturating adds as a function of the R bits[9:8] of the immediate field. The saturating add forces all “ones” when an overflow occurs on an a positive number. If the result of the adder is a negative number the adder is forced to all “zero's”. The final result can be shifted in accordance with the immediate field S [13:10] controls.

Bits [16:1] of the shift and round unit are selected and transferred to the register vVD as shown in Table 6. Table 5 shows which MAC unit is operating on specific elements of the vVA register. For example, for a 6 tap filter, MAC unit 0 operates on doublet [15:0] of elements 0, 1, 2, 3, 4, and 5 in the vVA register and produces one 16-bit result. MAC unit 0 then operates on elements 6, 7, 8, 9, 10, and 11, and produces another result. Selecting a 4 tap filter allows 28 filters in 31 clocks, while a 5 tap filter will allow 25 filters in 29 clocks. A 6 tap filter allows 24 filters in 29 clocks. The results of a 6 tap filter are placed in the vVD vector register as shown in Table 6, other filters have similar repeating output characteristics.

This is a multi-pipe instruction. The G field selects the register containing the starting element which must be zero and the vector length as specified in Table 5.
Number of taps=Y[1:0] (16-bit signed input and output)
0x0=4 taps,
0x1=5 taps,
0x2=6 taps,
0x3=6 taps, used for 16x16 Macroblock
Shift count=(Arithmetic Right Shift) S[13:10]
0x0=no shift
0x1=1, 0x2=2, 0x3=3, 0x4=4, 0x5=5, 0x6=6, 0x7=7, 0x8=8
0x9=9, 0xA=10, 0xB=11, 0xC=12, 0xD=13, 0xE=14, 0xF=15
Round=R[9:8]
0x0=no round
0x1=round and no saturation
0x2=round with 8-bit saturation
0x3=round with 16-bit saturation

A typical implementation of the instruction (for shifting and rounding of MAC units) is:

```
    SR[29:1] <--- AD[28:0]
    SR[0] <-- 0
    SR[29:0] <--- SR[29:0] >> S[13:10]  //shift count, sign extended
shift
if R[9:8]=0x0  //no rounding
    vVD[15:0] <-- SR[16:1]
if R[9:8]=0x1 //Round & No Saturation
    SR[29:0] <-- SR[29:0]+1
    vVD[15:0] <-- SR[16:1]
else //R[9:8]=0x2 // Round & Saturate 0xFF<=X>=0x00
    SR[29:0] <-- SR[29:0]+1
```

| | |
|---|---|
| If | SR[29] = 1 |
| | SR[16:1] <-- 0x0000 |
| If | SR[19] = 0 and SR[18:9] !=0 |
| | SR[16:1] <-- 0xFFFF |
| | SR[16:1] <-- SR[16:1] |

```
    end if
    vVD[15:0] <-- SR[16:1]
```

The “Vector Add & Shift Right Arithmetic & Round Convolution FIR Filter (vaddsrar)” instruction is shown in FIG. 56. The format of the instruction is:
vaddsrar vVD,vVA,vVB,C,I,P,gG

The vector pipe is selected by the 3-bit P field. The arithmetic functional unit is selected by the hardware. The vector register specified by the vVA field has each element added to the vector element of vector register vVB. The vVD vector register is shifted right, sign-extending into the lower order bits, with the sign bit remaining in bit [15]. The shift count is controlled by the count in the immediate field I[12:9]. If the C[13] field bit is a “one” and the sum is positive a plus one is added to the LSB−1. If the C[13] field bit is a “one” and the sum is negative a minus one is added to the LSB−1. If C[13] is equal to “zero” or the shift count is “zero” no rounding takes place. The G field selects the register containing the starting element and vector length.

A typical implementation is:

```
i = 1, j = Starting Element, K[16:0] = temp register
While (i <= Vector Length)
  K[0] <- 0
  K[16:1] <- vVA(j)[15:0] + vVB(j)[15:0]
  K[16:0] <- K[16:0] >> I[12:9], K[16:16-I[12:9]] <- K[16]
  K[16:0] <- K[16:0] + (K[16])? − C[13]: + C[13]
  vVD(j)[15:0] <- K[16:1]
  i++, j = (j+1) mod 32;
endwhile
```

[(K[16])?−C[13]:+C[13] means that if the value of K bit 16 is true, add minus C bit 13, if K bit 16 is false, add plus C bit 13 to K[16:0]. Thus, this is either adding one bit or not to temporary register K[16].]

The preceding has been a description of a preferred embodiment of a vector processor with special purpose register and a high speed memory access system. Although numerous details have been provided for the purpose of explaining the system, the scope of the invention is defined by the appended claims.

What is claimed is:

1. A vector processor comprising:
a first plurality of vector registers;
a second plurality of vector registers;
a memory coupled to all of the first plurality and the second plurality of vector registers;
a plurality of convolvers each for executing instructions, and each coupled to one of the first plurality and one of the second plurality of vector registers;
wherein the convolvers simultaneously perform a group of comparisons between a first smaller image block stored in one of the first plurality of vector register and a second larger image block stored in at least one of the second plurality of vector registers.

2. A vector processor as in claim 1 further comprising a memory coupled to receive results from the convolvers.

3. A vector processor as in claim 2 wherein the first plurality of registers are arranged serially such that data stored in a first register of the first plurality of registers flows to a second register of the first plurality of registers, and then to a third register of the first plurality.

4. A vector processor as in claim 3 wherein each convolver is configured to perform a sum of absolute differences operation.

5. A vector processor as in claim 3 wherein each convolver operates in response to a different range of clock signals.

6. A vector processor as in claim 2 wherein the memory comprises a first-in, first-out memory.

7. A vector processor as in claim 6 further comprising a multiplexer coupled to outputs of the first-in first-out memory.
